(19) United States
(12) Patent Application Publication
(10) Pub. No.: US 2024/0136088 A1
(43) Pub. Date: Apr. 25, 2024

(54) SMART COMPOSITE CONDUCTORS AND METHODS OF MAKING THE SAME

(71) Applicant: TS Conductor Corp., Huntington Beach, CA (US)

(72) Inventors: Jianzhong Jason HUANG, San Clemente, CA (US); Qing HE, Pierrefonds (CA)

(21) Appl. No.: 18/383,308

(22) Filed: Oct. 23, 2023

Related U.S. Application Data
(60) Provisional application No. 63/419,088, filed on Oct. 25, 2022.

(51) Int. Cl. H01B 9/00; G02B 6/02; G02B 6/44

(52) U.S. Cl. CPC H01B 9/005; G02B 6/02; G02B 6/4429

(57) ABSTRACT

An apparatus includes a strength member including a core formed of a composite material, and having a first glass transition or melting temperature. An encapsulation layer is disposed around the core. An optical fiber assembly is disposed in the core and includes a fiber core and a fiber encapsulation layer disposed therearound that has a second glass transition or melting temperature that is greater than the first glass transition or melting temperature. A conductor layer is disposed around the strength member. A coupler may be coupled to an axial end of the apparatus. The coupler may define an aperture through a wall thereof and a portion of the optical fiber assembly is routed therethrough. A system may include a control unit configured to receive a sensing signal from the fiber assembly and transmit the signal or determine a value of the operating parameter and transmit the value to the receiver.

### CROSS-REFERENCE TO RELATED APPLICATIONS

This application claims priority to and benefit of U.S. Provisional Application No. 63/419,088, filed Oct. 25, 2022, entitled “Smart Composite Conductors and Methods of Making the Same,” the entire disclosure of which is incorporated herein by reference.

### TECHNICAL FIELD

The embodiments described herein relate generally to conductors for use in grid transmission applications.

### BACKGROUND

The electrical grid is a major contributor to greenhouse emissions and global warming. The US electrical grid is more than 25 years old and globally about 2,000 TWh electricity is wasted annually, and about 1 Billion Metric Ton of GHG emission is associated with just compensatory generation. As the demand for electricity grows, there is an increased demand for higher capacity electricity transmission and distribution lines. The amount of power delivered by an electrical conductor is dependent on the current-carrying capacity (also referred to as the ampacity) of the conductor transmitting the electric current. It is desirable to sense various operating parameters of electrical conductors during operation of electrical conductors for rapid identification of line faults and/or atmospheric conditions, and addressing any issues in a rapid fashion.

### SUMMARY

Embodiments described herein relate generally to systems and methods for electrical transmission using composite conductors and, in particular, to electrical conductors that include a strength member including a composite core and an encapsulation layer disposed around the composite core, and a conductive layer(s) that may include a plurality of strands of a conductive material disposed around the strength member. An optical fiber assembly is disposed in the composite core or in the encapsulating layer around the composite core and is configured to sense one or more operating parameters of the conductor. The optical fiber assembly includes a fiber core and a fiber encapsulation layer that has a higher glass transition temperature or melting temperature than a glass transition temperature or melting temperature or the processing temperature of the composite core such that the optical fiber assembly can be disposed in or otherwise, embedded in the composite core during a manufacturing process of the composite core or the strength member. Moreover, the optical fiber assembly may have a bend radius of equal to or less than 250 mm and/or have a cladding having a thickness of greater than 80 microns such that the optical fiber assembly has a micro-bending induced optical energy transmission loss of equal to or less than about 5 dB/km.

In some embodiments, an apparatus includes a strength member. The strength member includes a core formed of a composite material, the core having a first glass transition temperature or melting temperature. An encapsulation layer is disposed around the core. An optical fiber assembly is disposed in the core. The optical fiber assembly includes a fiber core and a fiber encapsulation layer disposed around the fiber core. The fiber encapsulation layer has a second glass transition temperature or melting temperature that is greater than the first glass transition temperature or melting temperature or the processing temperature of the strength member. A conductor layer is disposed around the strength member.

In some embodiments, an apparatus includes a strength member. The strength member includes a core formed of a composite material and an encapsulation layer disposed around the core. An optical fiber assembly is disposed in the core. The optical fiber assembly includes a fiber core and a fiber encapsulation layer disposed around the core, the fiber core including a central core and a cladding. In some embodiments, the cladding has a thickness in a range of about 80 μm to about 1,000 μm. A conductor layer is disposed around the strength member.

In some embodiments, an apparatus includes a strength member. The strength member includes a core formed of a composite material and an encapsulation layer disposed around the core. An optical fiber assembly is disposed in the core. The optical fiber assembly includes a fiber core and a fiber encapsulation layer disposed around the core, the fiber core including a central core and a cladding. In some embodiments, the optical fiber assembly has a bend radius of equal to or less than about 250 mm such that the optical fiber assembly has a micro-bending induced optical energy transmission loss of equal to or less than about 5.0 dB/km. A conductor layer is disposed around the strength member. In some embodiments, the optical fiber assembly has a bend radius of equal to or less than about 100 mm. In some embodiments, the optical fiber assembly has a bend radius of equal to or less than about 10 mm.

In some embodiments, a system includes a conductor including a strength member. The strength member includes a core formed of a composite material, and an encapsulation layer disposed around the core. An optical fiber assembly is disposed in the core. The optical fiber assembly includes a fiber core and a fiber encapsulation layer A conductor layer is disposed around the strength member. A controller is communicatively coupled to the optical fiber assembly. The controller is configured to: receive a sensing signal from the optical fiber assembly, the sensing signal indicative of an operating parameter of the conductor. The controller is also configured to at least one of: transmit the sensing signal to a receiver, or interpret the signal to determine a value of the operating parameter and transmit the value of the operating parameter to the receiver.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is a schematic illustration of a conductor for use in grid electrical transmission that includes a strength member including a composite core and an encapsulation layer, an optical fiber assembly disposed in the composite core, and a conductor layer disposed around the strength member, according to an embodiment.

FIG. 1B is a front cross-section view of an optical fiber assembly that may be disposed in the conductor of FIG. 1A, according to an embodiment.

FIG. 1C is a plot of bend radiuses of optical fibers, according to various embodiments.

FIG. 2 is front cross-section view of a conductor, according to an embodiment.

FIG. 3 is a front cross-section view of a conductor, according to an embodiment.

FIG. 4 is a front cross-section view of a conductor, according to an embodiment.

FIG. 5 is a schematic illustration of a system that includes a controller and an assembly including a conductor coupled to a coupler, according to an embodiment.

FIG. 6 is a schematic illustration of a system that includes a controller and an assembly including a conductor coupled to a coupler, according to an embodiment.

FIG. 7 is a schematic illustration of an assembly that includes a first conductor coupled to a second conductor via a coupler, according to an embodiment.

FIG. 8A is a schematic illustration of a stripping tool for stripping an encapsulation layer of a strength member of a conductor to allow accessing of a composite core of the strength member and thereby, at least a portion of an optical fiber assembly disposed therein, according to an embodiment.

FIG. 8B is a side view of an axial end of a composite core of a strength member of a conductor that has been stripped off an encapsulation layer via the stripping tool of FIG. 8A and a portion of which has been removed to allow access to a portion of an optical fiber assembly disposed therein, according to an embodiment.

FIG. 9 is schematic illustration of a system for sensing operating parameters of a conductor and transmitting the operating parameters or determined values of the operating parameters to a remote server, according to an embodiment.

FIG. 10 is schematic block diagram of a controller that is included in the systems of FIGS. 5, 6, and 9, according to an embodiment.

FIG. 11 is schematic illustration of a system for transmitting sensing signals received from an optical fiber assembly of conductor to a remote server via communication wires, according to an embodiment.

FIG. 12 is a schematic flow chart of a method for manufacturing a conductor including a strength member that includes a composite core having an optical fiber assembly disposed in the composite core and an encapsulation layer disposed around the composite core, and a conductor layer disposed around the strength member, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for electrical transmission using composite conductors and, in particular, to electrical conductors that include a strength member including a composite core and an encapsulation layer disposed around the composite core, and a conductive layer(s) that may include a plurality of strands of a conductive material disposed around the strength member. An optical fiber assembly is disposed in the composite core and is configured to sense one or more operating parameters of the conductor. The optical fiber assembly includes a fiber core and a fiber encapsulation layer that has a higher glass transition temperature or melting temperature than a glass transition temperature or melting temperature of the composite core such that the optical fiber assembly can be disposed in or otherwise, embedded in the composite core during a manufacturing process of the composite core or the strength member. Moreover, the optical fiber assembly may have a bend radius of equal to or less than 250 mm and/or have a cladding having a thickness of greater than 80 micron such that the optical fiber assembly has a micro-bending induced optical energy transmission loss of equal to or less than about 5 dB/km.

The American Society of Civil Engineers (“ASCE”) reports that an estimated 70% of transmission and distribution lines are well into the second half of their 50-year life expectancy, and some lower voltage components are even over 100 years old. PJM, a regional electrical transmission organization reports that two-thirds of all bulk electric system assets on their grid are more than 40 years old and more than one third of their transmission assets are more than 50 years old. Western Area Power Administration (“WAPA”) and Southwestern Power Administration (“SWPA”), for example, built the backbone grid in the Central U.S. in the 1940s and 1950s. Regulators and legislation across the country are establishing mandates to accelerate the renewable generation in response to climate change. The US government has also set a goal to zero carbon electricity by 2035, and zero carbon economy by 2050. Decarbonization and clean energy procurement targets set by states, utilities, and corporations for the not-so-distant future will require high levels of new renewable energy capacity to be quickly and efficiently integrated onto the power grid. The large influx of new generation capacity will necessitate an increase in transmission capacity to alleviate congestion and reliability issues that will arise as a result. While new, large-scale transmission infrastructure will be a key component to assist in this clean energy transition, regulatory and planning obstacles often get in the way of their timely construction. Therefore, improvement of the current grid infrastructure is a more efficient solution to providing more efficient electrical transmission and reduce transmission losses.

The US PowerGrid is faltering just as millions of Americans are becoming more dependent on it as the US moves toward electrifying everything to control GHG emission and climate change. The unusual and extreme weather patterns from climate change are imposing greater stress on the electric system, leading to more frequent outages. Per a Wall Street Journal analysis, there were fewer than two dozen major disruptions in 2000, and this has increased by a factor of six in 2020. Extreme weather patterns are projected to increase further in the coming years. The current grid, featuring century old conductor technology, is also inefficient as the transmission planning process has not historically considered solutions that improve the operational efficiency of existing transmission and distribution system. At the rate of 8.3% loss, the Global PowerGrid is losing about 2,000 TWhr of electricity annually. To make up for the loss, the compensatory generation alone is responsible for 1 billion metric ton of GHG each year. An efficient conductor will not only save system cost and reduce electricity price for rate payers, but it could also avoid substantially investment into generation capacity, and reduce GHG emission substantially.

In addition, many places in the world provide electrical transmission using underground conductors, or are aiming to adopt underground electrical transmission. For example, in California, above ground conductors have been associated with sparking wild fires that have caused significant damage to property and loss of life over the last few years. Using underground electrical conductors could inhibit this risk because above ground vegetation would no longer be exposed to conductors. However, underground conductor in places like California may be subject to earthquake damage, ground movement that can cause conductor strain, capacity constraint due to how much temperature the conductor can handle, and electrical discharges due to breach of insulation. Conventional conductors, however, are not equipped to detect and report damages causes by earthquakes or ground movement.

One way to improve electrical transmission is to provide conductors that are lighter than traditional conductors, have higher strength, provide high electrical transmission, and can be easily integrated in the current electrical grid system, as well as underground transmission systems. Another way is to integrate sensors within the conductors such that various operating parameters of the conductors such as, for example, sag, fault location, temperature sensing, tension load, etc., can be measured passively and/or in real time. This can lead to awareness of the conductor and circuit condition for in system reliability and resiliency, operational flexibility, and optimization of the PowerGrid performance at all times, including much needed accurate situational awareness during extreme weather events.

Conventional conductors, however, fail to provide such benefits. Conventional conductors with steel cores are heavy and have high thermal expansion and thermal sag. Conductors with Invar core are expensive and can only pair with aluminum alloy to make up for the poor invar strength. They also have high impedance and experience transmission losses. ACCR conductors with ceramic fibers are very expensive and vulnerable to bending failures due to their poor tensile strength. Similarly CFCC conductors while having low sag, are also vulnerable to bending failures and due to their poor compression strength.

In contrast, embodiments of the smart conductors that include a strength member and a conductor layer disposed around the strength member, and that include an optical fiber assembly disposed in a core of the strength member, may provide one or more benefits including, for example: 1) providing a strength member that has a gap free encapsulation layer around a composite core that inhibits presence of air, oxygen, and/or electrolytes at the interface between the encapsulation layer and the core, thereby protecting encapsulation layer and core interface from corrosion, and the core from oxidation, moisture plasticization, ultraviolet (“UV”) light, corrosion, and generally environmental degradation; 2) protecting the composite core from the from compression and bending failures via the encapsulation layer; 3) providing cushioning via the encapsulation layer to protect the composite core during crimp coupling of the conductor to conventional crimp couplers, thereby reducing installation cost because special tools, special training, or custom couplers are not required for installation; 4) increase conductor strength and preserve residual tension in the composite core during manufacturing of the strength member such that any compressive stress in the conductor must first overcome the pre-existing tension in the composite core, thereby delaying buildup of compressive stress and inhibiting compression buckling failure that is associated with conventional conductors, as well as increasing bending stiffness; 5) disposing or otherwise, embedding one or more optical sensing assemblies within the composite core instead of a separate steel or aluminum tube as with conventional conductors, thereby causing the optical fiber assembly to be in intimate contact with the composite core of the conductor to enable the optical fiber assembly to measure strain, sag, or any change in conductor length with high fidelity; 6) protecting the optical fiber assembly from moisture and environmental degradation by disposing the optical fiber assembly in the composite core and disposing the encapsulation layer therearound; 7) providing a fiber encapsulation layer having a high glass transition temperature or melting temperature (“T_{g}”) around a fiber core of the optical fiber assembly so as to allow integration of the optical fiber assembly in the strength member during a manufacturing process of the conductor without causing melting of the fiber encapsulation layer; 8) allowing accurate distributed sensing of temperature to enable monitoring of temperature anomalies in the environment around the conductor, for example, to detect hot spots, cold spots, heatwaves, wildfires, winter storms, etc.; 9) disposing the optical fiber assembly in the composite core at strategic locations to allow easy access to the optical fiber assembly for splicing with another conductor, or coupling to a controller; 10) providing a special cutting tool to allow users (e.g., repairmen or installation workers) to rapidly and facilely access the optical fiber assembly from within the composite core; 11) reducing operational costs and transmission losses by allowing real time sensing of conductor faults and other operational parameters, and transmission to remote servers for rapid identification of transmission problems and responding thereto; 12) reducing optical transmissions losses by providing optical fiber assemblies or configuring optical fiber assemblies to have low bend radius; and 12) enabling data transmission from opto-electronic instruments to central control stations to monitor facility or service provided by the central control stations.

As described herein, the term “bend radius” refer to the minimum allowable radius of curvature that an optical fiber can be safely bent without causing excessive optical signal loss or damage to the optical fiber.

As used herein, the term “micro-bending” is defined as the attenuation of an optical fiber that relates to the light signal loss associated with lateral stresses along the length of the optical fiber. The loss is due to the coupling from the fiber's guided fundamental mode to lossy, higher-order radiation modes. Mode coupling occurs when fibers suffer small random bends along the optical fiber axes.

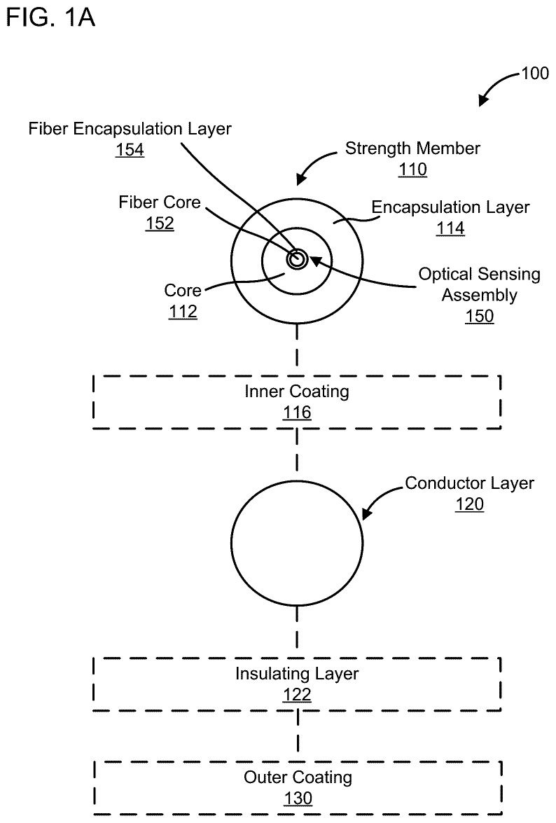

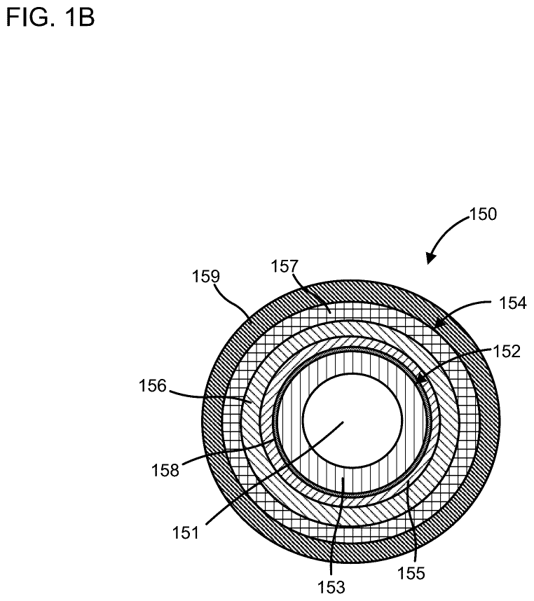

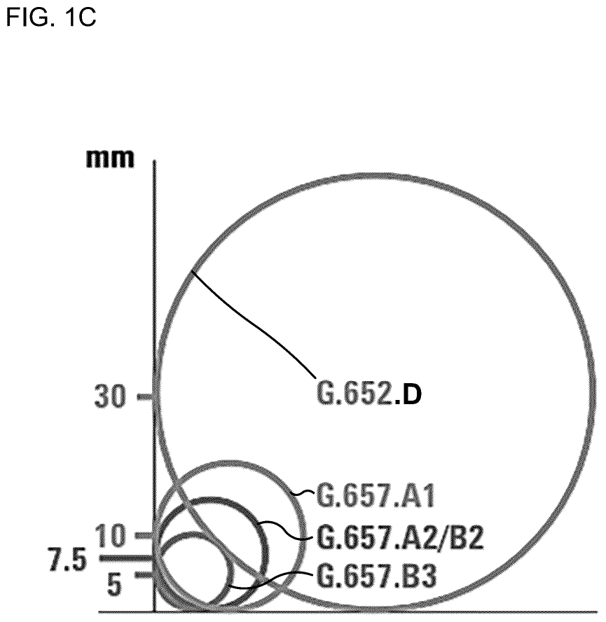

FIG. 1A is a schematic illustration of a conductor 100, according to an embodiment. The conductor 100 includes a strength member 110 including a composite core 112 (also referred to herein as “core 112”) and an encapsulation layer 114 disposed around the core 112, an optical fiber assembly 150 disposed in the core, a conductor layer 120 disposed around the strength member 110, and optionally, an insulating layer disposed on the conductor layer 120, an outer coating 130 disposed on the insulator layer or the conductor layer 120, and/or an inner coating 116 disposed around strength member 110 i.e., between the conductor layer 120 and the strength member 110.

In some embodiments, the encapsulation layer 114 is disposed circumferentially around the core 112. The core 112 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material includes a carbon fiber reinforced composite of a thermoplastic or thermoset resin. The reinforcement in the composite strength member(s) can be discontinuous, for example, include whiskers or chopped fibers, or continuous fibers in substantially aligned configurations (e.g., parallel to axial direction) or randomly dispersed (including helically wind or woven configurations). In some embodiments, the composite material may include a continuous or discontinuous polymeric matrix composites reinforced by carbon fibers, glass fibers, quartz, or other reinforcement materials, and may further include fillers or additives (e.g., nanoadditives). In some embodiments, the core 112 may include a carbon composite including a polymeric matrix of epoxy resin cured with anhydride hardeners.

The core 112 may have any suitable cross-sectional width (e.g., diameter). In some embodiments, the core 112 has a diameter in a range of about 3 mm to about 15 mm, inclusive (e.g., 3, 4, 5, 6, 7, 8, 9, 10, 11, 12, 13, 14, or 15 mm, inclusive). In some embodiments, the core 112 may have a diameter in a range of about 5 mm to about 10 mm, inclusive. In some embodiments, the core 112 may have a diameter in a range of about 10 mm to about 15 mm, inclusive. In some embodiments, the core 112 may have a diameter in a range of about 7 mm to about 12 mm, inclusive. In some embodiments, the core 112 may have a diameter of about 9 mm.

The core 112 may have a first glass transition temperature (e.g., for thermoset composites), or melting point (e.g. for thermoplastic composites). In some embodiments, the first glass transition temperature or melting temperature is in a range of about 60 degrees Celsius to about 350 degrees Celsius, inclusive (e.g., about 100, about 110, about 120, about 130, about 140, about 150, about 160, about 170, about 180, about 190, about 200, about, 210, about 220, about 230, about 240, about 250, about 260, about 270, about 280, about 290, about 300, about 310, about 320, about 330, about 340, or about 350 degrees Celsius, inclusive). In some embodiments, the first glass transition temperature or melting temperature may be at least about 70 degrees Celsius (e.g., at least 100, at least 120, at least 140, at least 150, at least 160, at least 180, at least 200, at least 220, at least 240, at least 260, at least 28, or at least 300, degrees Celsius, inclusive). In some embodiments, the strength member 110 may have a processing temperature, i.e., a temperature at which the strength member is manufactured or fabricated, which is substantially similar to the first glass transition temperature, for example, in a range of about 60 degrees Celsius to about 350 degrees Celsius.

The glass transition temperature or melting temperature of the core 112 may correspond to a threshold operating temperature of the conductor 100, which may limit the ampacity of the conductor 100. In other words, a maximum amount of current that can be delivered through the conductor 100 is the current at which the operating temperature of the conductor 100, or at least the temperature of the core 112 is less than the glass transition temperature or melting temperature of the composite core 112.

In some embodiments, the core 112 defines a circular cross-section. In some embodiments, the core 112 may define an ovoid, elliptical, polygonal, or asymmetrical cross-section. In some embodiments, the strength member 110 may include a single core 112. In other embodiments, the strength member 110 may include multiple cores, for example, 2, 3, 4, or even more, with the encapsulation layer 114 being disposed around the multiple cores or around each individual core. In such embodiments, each of the multiple cores may be substantially similar to each other, or at least one of the multiple cores may be different from the other cores (e.g., have a different size, different shape, formed from a different material, have components such as the optical fiber assembly 150 embedded therein, etc.).

The optical fiber assembly 150 is disposed in the core 112, for example, embedded within the core 112 during the manufacturing of the core 112, or otherwise during manufacturing of the strength member 110. While generally described as being disposed in the core 112, in some embodiments, the optical fiber assembly 150 may be disposed at any suitable location within the conductor 100. For example, in some embodiments, the optical fiber assembly 150 may be disposed in the encapsulation layer 114 around the core 110. In some embodiments, the optical fiber assembly 150 may be disposed in the conductor layer 120, for example, disposed inside one or more conductive strands included in the conductor layer 120. In some embodiments, the optical fiber assembly 150 may be disposed in the insulation layer(s) 122 that may be disposed around the conductor layer 120. The optical fiber assembly 150 may include a single mode or a multimode optical fiber assembly or any combination of single or multimode optical fiber assembly, and is configured to transmit optical energy therethrough.

The optical fiber assembly 150 may be disposed axially along or otherwise parallel to a central axis of the core 112 and may extend along an entire length of the core 112, and thereby, the conductor 100. The optical fiber assembly 150 includes a fiber core 152 and a fiber encapsulation layer 154 disposed around the fiber core 152. The fiber core 152 may include an optical fiber (e.g., a single-mode optical fiber, a multi-mode optical fiber, a graded index fiber, a step index fiber, a glass optical fiber, a plastic optical fiber, any other suitable optical fiber or combination thereof) that is capable of transmitting optical energy or light having a wavelength in a range of about 100 nm to about 1 mm, inclusive (e.g., from the ultraviolet to the infrared range).

FIG. 1B is a front-cross section view of the optical fiber assembly 150 showing one or more layers that may be included in the optical fiber assembly 150, according to an embodiment In some embodiments, the fiber core 152 may include a central core 151 and a cladding 153 disposed around the central core 151. In some embodiments, the central core 151 has a first refractive index, and the cladding 153 disposed around the central core has a second refractive index lower than the first refractive index to confine light transmitted through the central core 151. While FIG. 1B shows the optical fiber assembly 150 as including a plurality of layers, this is for illustrative purposes only and one or more of the layers included in the optical fiber assembly 150 may be optional, may be arranged or disposed in any suitable arrangement, or the optical fiber assembly 150 may include additional layers not shown in FIG. 1B and as described herein. All such embodiments are envisioned and should be considered to be within the scope of the present application.

In some embodiments, the central core 151 includes a doped silica. In some embodiments, the doped silica may include germanium and/or alkali metal, i.e., the silica may be doped with germanium and/or alkali metal. In some embodiments, the central core 151 includes doped silica to provide a positive refractive index relative to pure silica In some embodiments, the central core 151 includes pure silica (i.e., silica that is not doped). In some embodiments, the central core 151 may include a solid core In some embodiment, the central core 151 may include a hollow core (e.g., define a channel or conduit therethrough). In such embodiments, the fiber core 152 may include a hollow-core photonic-crystal fiber. In some embodiments, the fiber core 152 may include a single central core 151 as shown in FIG. 1B. In some embodiments, the fiber core 152 may include multiple cores (e.g., include a multi-core fiber). In such embodiments, each of the multiple cores may be used to transmit the same optical signal or different optical signals, for example, signals carrying different information or used to measuring different operating parameters of the conductor 100.

In some embodiments, the central core 151 has a diameter of at least about 2 μm, at least about 2.5 μm, at least about 3 μm, at least about 3.5 μm at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 10.5 μm, at least about 11 μm, at least about 11.5 μm, at least about 12 μm, at least about 12.5 μm, at least about 13 μm, at least about 13.5 μm, at least about 14 μm, at least about 15 μm, at least about 16.5 μm, at least about 17 μm, at least about 17.5 μm, at least about 18 μm, at least about at least about 18.5 μm, at least about 19 μm, at least about 19.5 μm, at least about 20 μm, at least about 22 μm, at least about 24 μm, at least about 26 μm, at least about 28 μm, at least about 30 μm, at least about 32 μm, at least about 34 μm, at least about 36 μm, at least about 38 μm, at least about 40 μm, at least about 42 μm, at least about 44 μm, at least about 46 μm, at least about 48 μm, at least about 50 μm, at least about 52 μm, at least about 54 μm, at least about 56 μm, at least about 58 μm, at least about 60 μm, or at least about 62 μm. In some embodiments, the central core 151 has a diameter of no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, no more than about 15 μm, no more than about 14.5 μm, no more than about 14 μm, no more than about 13.5 μm, no more than about 13 μm, no more than about 12.5 μm, no more than about 12 μm, no more than about 11.5 μm, no more than about 11 μm, no more than about 10.5 μm, or no more than about 10 μm. Combinations of the above-referenced thicknesses are also possible (e.g., at least about 2 μm and no more than about 10.5 μm or at least about 12 μm and no more than about 40 μm), inclusive of all values and ranges therebetween.

In some embodiments, the cladding 153 is configured to inhibit transmission of optical energy therethrough to prevent transmission losses. In some embodiments, the cladding 153 includes a silica In some embodiments, the cladding 153 includes an undoped silica In some embodiments, the cladding 153 includes a silica doped with at least one of fluorine, chlorine, or an alkali metal. While FIG. 1B shows the optical fiber assembly 150 as including a single cladding 153, in some embodiments, the optical fiber assembly 150 may include multiple cladding layers. For example, the cladding 153 can include 2, 3, or more layers (e.g., include a double clad or triple clad fiber).

In some embodiments, the cladding 153 may have a thickness configured to reduce micro-bending induced optical energy transmission losses, for example, reduce the micro-bending induced optical energy transmission losses to be equal to or less than 5 dB/km Expanding further, embedding the optical fiber assembly 150 in the core 112 that may be formed ofa composite material can generate random strains on the optical fiber assembly 150 during the curing process of the core 112 causing micro-bending. The micro-bending can build up along the length of the fiber, and this micro-bending can be significant for optical fibers having thin claddings (e.g., having a thickness of less than 80 μm). As described herein, the cladding 153 of the optical fiber assembly 150 has a thickness that significantly reduces micro-bending induced optical energy transmission losses, for example, by increasing the stiffness of the optical fiber assembly 150.

In some embodiments, the cladding 153 has a thickness of at least about 80 μm, at least about 90 μm, at least about 100 μm, at least about 110 μm, at least about 120 μm, at least about 130 μm, at least about 140 μm, at least about 150 μm, at least about 160 μm, at least about 170 μm, at least about 180 μm, at least about 190 μm, at least about 200 μm, at least about 210 μm, at least about 220 μm, at least about 230 μm, at least about 240 μm, at least about 250 μm, at least about 260 μm, at least about 270 μm, at least about 280 μm, at least about 290 μm, at least about 300 μm, at least about 310 μm, at least about 320 μm, at least about 330 μm, at least about 340 μm, at least about 350 μm, at least about 360 μm, at least about 370 μm, at least about 380 μm, at least about 390 pin, at least about 400 μm, at least about 410 μm, at least about 420 μm, at least about 430 μm at least about 440 μm, at least about 450 μm, at least about 460 μm, at least about 470 μm, at least about 480 μm, at least about 490 μm, at least about 500 pin, at least about 550 μm, at least about 600 μm, at least about 650 μm, or at least about 700 μm. In some embodiments, the cladding 153 has a thickness of no more than about 2,000 μm, no more than about 1800 μm, no more than about 1500 μm, no more than about 1300 μm, no more than about 1,000 pin, no more than about 800 μm, no more than about 500 μm, no more than about 400 μm, no more than about 300 μm, no more than about 200 μm, or no more than about 100 μm. Combinations of the above-referenced thicknesses are also possible (e.g., at least about 150 μm and no more than about 1,000 μm or at least about 400 μm and no more than about 500 μm), inclusive of all values and ranges therebetween.

In some embodiments, the cladding 153 has a thickness in a range of about 800 μm to about 2,000 μm. In some embodiments, the cladding 153 has a thickness in a range of about 150 μm and to about 1,000 μm. In some embodiments, the cladding 153 may have a thickness of about 80 μm, about 100 μm, about 150 μm, about 200 μm, about 250 μm, about 300 μm, about 350 μm, about 400 μm, about 500 μm, about 600 μm, about 700 μm, about 800 μm, about 900 μm, or about 1,000 μm, inclusive.

The fiber encapsulation layer 154 is disposed around the fiber core 152. The fiber encapsulation layer 154 may be configured to protect the fiber core 152 from mechanical and environmental stresses, for example, to reduce micro-bending induced losses, and/or protect the optical fiber from heat that may be generated during formation of the core 112 of the strength member 110, and may include a single layer or multiple layers.

As show in FIG. 1B, in some embodiments, the fiber encapsulation layer 154 may include a protective layer 155 or buffer layer disposed on the fiber core 152. In some embodiments, the protective layer 155 may include an acrylate based coating having a thickness in a range of about 10 μm to about 300 μm (e.g., about 10, 20, 30, 40, 50, 60, 70, 80, 90, 100, 110, 120, 130, 140, 150, 160, 170, 180, 190, 200, 210, 220, 230, 240, 250, 260, 270, 280, 290, or about 300 μm, inclusive).

In some embodiments, the fiber encapsulation layer 154 may include a temperature resistant layer 156 disposed on the protective layer 155, or in place of the protective layer 155 such that the temperature resistant layer 156 is disposed directly on the fiber core 152. In some embodiments, the temperature resistant layer 156 may have a second glass transition temperature or melting temperature that is greater than the first glass transition temperature or melting temperature of the core 112, or processing temperature of the strength member 110. In some embodiments, the second glass transition temperature or melting temperature may be in a range of about 80 degrees Celsius to about 450 degrees Celsius, inclusive (e.g., about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 350, about 360, about 370, about 380, about 390, about 400, about 410, about 420, about 430, about 440, or about 450 degrees Celsius, inclusive).

In some embodiments, the second glass transition temperature or melting temperature may be at least about 80 degrees Celsius. In some embodiments, the second glass transition temperature or melting temperature may be at least about 100 degrees Celsius. In some embodiments, the second glass transition temperature or melting temperature may be at least about 120 degrees Celsius. In some embodiments, the second glass transition temperature or melting temperature may be at least about 140 degrees Celsius. In some embodiments, the second glass transition temperature or melting temperature may be at least about 160 degrees Celsius. In some embodiments, the second glass transition temperature or melting temperature may be at least about 170 degrees Celsius. In some embodiments, the second glass transition temperature or melting temperature may be at least about 180 degrees Celsius. In some embodiments, the second glass transition temperature or melting temperature may be at least about 190 degrees Celsius. In some embodiments, the second glass transition temperature or melting temperature may be at least about 200 degrees Celsius. In some embodiments, the second glass transition temperature or melting temperature may be at least about 220 degrees Celsius. In some embodiments, the second glass transition temperature or melting temperature may be at least about 240 degrees Celsius. In some embodiments, the second glass transition temperature or melting temperature may be at least about 260 degrees Celsius. In some embodiments, the second glass transition temperature or melting temperature may be at least about 280 degrees Celsius. In some embodiments, the second glass transition temperature or melting temperature may be at least about 300 degrees Celsius. In some embodiments, the second glass transition temperature or melting temperature may be at least about 320 degrees Celsius. In some embodiments, the second glass transition temperature or melting temperature may be at least about 340 degrees Celsius. In some embodiments, the second glass transition temperature or melting temperature may be at least about 360 degrees Celsius. In some embodiments, the second glass transition temperature or melting temperature may be at least about 380 degrees Celsius. In some embodiments, the second glass transition temperature or melting temperature may be at least about 400 degrees Celsius. In some embodiments, the second glass transition temperature or melting temperature may be at least about 420 degrees Celsius. In some embodiments, the second glass transition temperature or melting temperature may be at least about 440 degrees Celsius. In some embodiments, the second glass transition temperature or melting temperature may be at least about 450 degrees Celsius.

In some embodiments, the temperature resistant layer 156 may include a temperature resistant coating or buffer layer having the second glass transition temperature or melting temperature. In some embodiments, the temperature resistant layer 156 may include a silicone and/or polyimide coating (e.g., a 180C silicone coating or a 280C silicone coating). In some embodiments, the temperature resistant layer 156 may have a thickness in a range of about 0.1 mm to about 3 mm, inclusive (e.g., a 180C silicone coating). In some embodiments, the temperature resistant layer 156 may have a thickness in a range of about 0.001 mm to about 0.1 mm, inclusive (e.g., a thin polyimide or a 280C silicone coating). In some embodiments, the temperature resistant layer 156 may have a thickness in a range of about 400 μm to about 1,000 μm, inclusive (e.g., about 400, 450, 500, 550, 600, 650, 700, 750, 800, 850, 900, 950, or 1,000 μm, inclusive).

In some embodiments, the temperature resistant layer 156 may also have a low Young's modulus (i.e., modulus of elasticity) that may allow protecting the central core 151 and cladding 153 by efficiently dissipating internal stresses that can arise when the exterior of the optical fiber assembly 150 is bent or subjected to an external force. That is, the soft and/or flexible thermal resistant layer 156 disposed on the fiber core 152 may also help to decrease strain toward a surface of the cladding 153, thereby reducing micro-bending losses.

In some embodiments, the thermal resistant layer 156 may have a Young's modulus of at least about 0.1 MPa, at least about 0.5 MPa, at least about 1 MPa, at least about 2 MPa, at least about 3 MPa, at least about 4 MPa, at least about 5 MPa, at least about 8 MPa, at least about 10 MPa, at least about 12 MPa, at least about 15 MPa, at least about 18 MPa, at least about 20 MPa, at least about 30 MPa, at least about 35 MPa, at least about 40 MPa, at least about 45 MPa, at least about 50 MPa, at least about 60 MPa, at least about 70 MPa, or at least about 80 MPa. In some embodiments, the thermal resistant layer 156 may have a Young's modulus of no more than about 1000 MPa, no more than about 500 MPa, no more than about 400 MPa, no more than about 300 MPa, no more than about 200 MPa, no more than about 100 MPa, no more than about 80 MPa, no more than about 50 MPa, no more than about 40 MPa, no more than about 30 MPa, no more than about 20 MPa, no more than about 10 MPa, or no more than about 5 MPa. Combinations of the above-referenced Young's modulus values also possible (e.g., at least about 0.5 MPa and no more than about 30 MPa or at least about 10 MPa and no more than about 400 MPa), inclusive of all values and ranges therebetween.

In some embodiments, the thermal resistant layer 156 is thermally stable up to about 400 degrees Celsius, up to about 350 degrees Celsius, up to about 330 degrees Celsius, up to about 300 degrees Celsius, up to about 280 degrees Celsius, up to about 250 degrees Celsius, up to about 220 degrees Celsius, up to about 200 degrees Celsius, up to about 150 degrees Celsius, or up to 100 degrees Celsius.

In some embodiments, the fiber encapsulation layer 154 may include a jacket 157 disposed on the temperature resistant layer 156, disposed on the protective layer 155 in embodiments in which the temperature resistant layer 156 is not included, or disposed directly on the fiber core 152 in embodiments in which each of the temperature resistant layer 156 and the protective layer 155 are excluded. The jacket 157 may be formed from any suitable material such as, for example, acrylate, fluoroacrylate, silicone, polyimide (PI), carbon, polyetheretherketone (PEEK), nylon, polybutylene terephthalate (PBT), polypropylene (PP), polyethylene (PE), low-smoke, zero halogen (LSZH) PE-PP, polyvinylchloride (PVC), polyvinylidene fluoride (PVDF), polyurethane (TPU), halogen free flame retardant polyurethane (HFFR), thermoplastic polyester elastomers (TPE), ethylene tetrafluoroethylene ETFE, TEFLON™, polyfluoroalkoxy TEFLON™, any other suitable material or a combination thereof. In some embodiments, the jacket 157 may include PEEK, nylon, or any other suitable material that is disposed tightly around the fiber core 152 or around inner layers of the fiber encapsulation layer 154 (e.g., the protective layer 155 and/or temperature resistant layer 156). In such embodiments, the jacket 157 may have a thickness in a range of about 400 μm to about 1,000 μm, inclusive (e.g., about 400, 450, 500, 550, 600, 650, 700, 750, 800, 850, 900, 950, or 1,000 μm, inclusive). In some embodiments, the jacket 157 may include PVC, PE, PVD, LSZH, or any other suitable material that is disposed loosely around the fiber core 152 or inner layers 155, 156 of the fiber encapsulation layer 154. In such embodiments, the jacket 157 may have a thickness in a range of about 900 μm to about 3,000 μm, inclusive (e.g., 900, 1,000, 1,200, 1,400, 1,600, 1,800, 2,000, 2,200, 2,400, 2,600, 2,800, or 3,000 μm, inclusive).

In some embodiments, the jacket 157 has a Young's modulus of greater than about 30 MPa. In some embodiments, the jacket 157 has a Young's modulus greater than the Young's modulus of the thermal resistant layer 156 to further protect the fiber core 152 from micro-bending losses. In some embodiments, the jacket 157 has Young's modulus of at least about 30 MPa, at least about 50 MPa, at least about 70 MPa, at least about 100 MPa, at least about 120 MPa, at least about 150 MPa, at least about 180 MPa, at least about 200 MPa, at least about 250 MPa, at least about 300 MPa, at least about 350 MPa, at least about 400 MPa, at least about 450 MPa, at least about 500 MPa, at least about 550 MPa, at least about 600 MPa, at least about 650 MPa, at least about 700 MPa, at least about 750 MPa, at least about 800 MPa, or at least about 850 MPa. In some embodiments, the jacket 157 has a Young's modulus of no more than about 2000 MPa, no more than about 1800 MPa, no more than about 1500 MPa, no more than about 1200 MPa, no more than about 1000 MPa, no more than about 800 MPa, no more than about 500 MPa, no more than about 200 MPa, no more than about 100 MPa, no more than about 80 MPa, or no more than about 50 MPa. Combinations of the above-referenced Young's modulus values also possible (e.g., at least about 100 MPa and no more than about 1000 MPa or at least about 30 MPa and no more than about 400 MPa), inclusive of all values and ranges therebetween.

In some implementations, it may be desirable to inhibit water ingress into the optical fiber assembly 150. Water diffusion into the optical fiber assembly 150 can lead to an irreversible attenuation in optical signals being transmitted through the optical fiber assembly 150. Moisture can also ingress into microcracks in the fiber core 152 and enlarge such microcracks which can reduce the life of the optical fiber assembly 150. The effect can be even more dramatic in cold weather when the diffused moisture can freeze and expand causing further damage or failure of the optical fiber assembly 150. While the encapsulation layer 114 disposed around the core 112 substantially inhibits moisture ingress into the core 112 and thereby, the optical fiber assembly 150, moisture may still be able to enter and diffuse into the optical fiber assembly 150, for example, during the manufacturing process of the strength member 110, from exposed axial ends of the optical fiber assembly 150 that may extend out of the strength member 110 (e.g., for coupling to the optical fiber assembly 150 of another conductor or terminating at a receiver or controller.

In some embodiments, the fiber encapsulation layer 154 may also include one or more water exclusion layers to inhibit moisture ingress into the optical fiber assembly 150 or at least a portion of the optical fiber assembly 150 (e.g., the fiber core 152) from moisture. For example, in some embodiments, the fiber encapsulation layer 154 may include an inner moisture exclusion layer 158 disposed around the fiber core 152, for example, disposed around the cladding 153. The inner moisture exclusion layer 158 may include a thin layer of a moisture resistant material that conformally or uniformly coats the fiber core 112 (e.g., disposed on the cladding 153) such to inhibit moisture ingress into the fiber core 152. In some embodiments, the inner moisture exclusion layer 158 may include a thin coating formed from carbon, metals (e.g., aluminum, gold, copper, alloys), or polymers (e.g., TEFLON®, nylon, etc).

In some embodiments, the fiber encapsulation layer 154 may additionally, or alternately include an outer moisture exclusion layer 159, that may be disposed around one or more inner layers of the fiber encapsulation layer 154, for example, around the jacket 157, or around the temperature resistant layer 156. In other words, the outer moisture exclusion layer 159 may form the outer most layer of the fiber encapsulation layer 154. In some embodiment, the outer moisture exclusion layer 159 may include a thin layer of a moisture resistant material that forms the outer most layer of the fiber encapsulation layer and is configured to inhibit moisture ingress into the fiber core 152. In some embodiments, the outer moisture exclusion layer 159 may include a thin coating formed from carbon, metals (e.g., aluminum, gold, copper, alloys), or polymers (e.g., TEFLON®, nylon, etc.) In some embodiments, the outer moisture exclusion layer 159 may include an additional component separate from the optical fiber assembly 150. For example, the outer moisture exclusion layer may include a tube (e.g., a metal tube such as a stainless steel or aluminum tube) defining a channel within which the optical fiber assembly 150 is disposed. In such embodiments, the optical fiber assembly 150 may be disposed loosely within the outer moisture exclusion layer 159, or the outer moisture exclusion layer 159 may be compressed or extruded over the fiber encapsulation layer 154 such that there is substantially no clearance between optical fiber assembly 150 and the outer moisture exclusion layer 159. In some embodiments, multiple optical fiber assemblies 150 may be disposed within a single outer moisture exclusion layer 159.

In some embodiments, the optical fiber assembly 150 includes at least one of G.657.A1, G.657.A2, G.657.B2, G.657.B3 or G.652.D optical fibers. An optical fiber assembly 150 that has a lower bend radius may correspond to having a lower micro-bending induced optical energy transmission losses. For example, FIG. 1C is a plot of bend radiuses of the G.652.D, G.657.A1, G.657.A2/B2, and G.657.B3 optical fiber assemblies, without any additional layers disposed thereon. While the G.652.D optical fiber has a bend radius of about 30 mm, the G657 A1 optical fiber assembly has a bend radius of about 10 mm, the G.657. A2/B2 assembly has a bend radius of about 7.5 mm, and the G.657.B3 optical fiber assembly has a bend radius of about 5 mm. This indicates that the G.657.A1, G.657.A2/B2, and the G.657.B3 optical fiber assemblies may have lower micro-bending induced optical energy transmission losses relative to the G.652.D optical fiber assembly.

In some embodiments, the optical fiber assembly 150 may include a G.657.B3 optical fiber, which includes a fiber core 152 having central core 151 including germanium doped silica, a silica cladding 153 having a thickness in a range of about 60 μm to about 130 μm, inclusive disposed around the central core 151, and an acrylate protective layer 155 having a thickness in a range of about 50 μm to about 200 μm, inclusive, disposed on the cladding 153. The G.657.B3 optical fiber assembly 150 may have a bend radius of less than 10 μm, and may have a micro-bending induced optical energy transmission loss of equal to or less than about 5 dB/km In some embodiments, to provide heat protection and/or to further reduce micro-bending induced optical transmission losses, the G.657.B3 optical fiber assembly 150 may include a fiber encapsulation layer 154 including one or more additional layers disposed on the protective layer 155. For example, the fiber encapsulation layer 154 may include a temperature resistant layer 156, for example, a silicone or polyimide coating, disposed on or around the protective layer 153, and having a thickness in a range of about 0.01 mm to about 3.0 mm, inclusive. The fiber encapsulation layer 154 may also include the jacket 157 disposed on the temperature resistant layer 156. The jacket 157 may be formed from PEEK or any other jacket material described herein, and may have a thickness in a range of about 80 μm to about 2,000 μm, inclusive. In some embodiments, including the temperature resistant layer 156 and/or the jacket 157 may reduce the micro-bending loss of the G.657.B3 optical fiber to be equal to or less than 1 dB/km.

In some embodiments, the optical fiber assembly 150 may include the G.657.B3 optical fiber as described herein, but having a thick cladding 153, for example, a cladding having a thickness in a range of about 100 μm to about 500 μm, inclusive. In some embodiments, a fiber encapsulation layer 154 that additionally includes the temperature resistant layer 156 is disposed around the acrylate protective layer 155. In some embodiments, the temperature resistant layer 156 may include a silicone buffer layer having a thickness in a range of about 80 μm to about 1,500 μm, inclusive (e.g., a 180C silicone layer). In some embodiments, the temperature resistant layer 156 may include a thin high temperature coating disposed on the acrylate protective layer 155, which has a thickness in a range of about 10 μm to about 100 μm, inclusive (e.g. a 280C silicone coating).

In some embodiments, the optical fiber assembly 150 may include a G.652.D optical fiber that includes a fiber core 150 having central core 151 including germanium doped silica, a cladding 153 having a thickness in a range of about 80 μm to about 1,000 μm, inclusive (e.g., about 200 μm) disposed around the central core 151, and a fiber encapsulation layer 154 including the protective layer 155 formed from acrylate and having a thickness in a range of about 100 μm to about 200 μm, inclusive disposed on the cladding 153. Conventional G.652.D optical fibers include a cladding having a thickness of about 62.5 μm. Such conventional G.652.D optical fiber generally has a bend radius of about 30 mm, and can have a micro-bending induced optical energy transmission loss of equal to or greater than about 300 dB/km. In contrast, the G.652.D optical fiber described herein having the thicker cladding 153 may have a micro-bending induced optical energy transmission loss of equal to or less than 5 dB/km.

In some embodiments, to provide heat protection and/or to further reduce micro-bending induced optical transmission losses, the fiber encapsulation layer 154 of the G.652.D optical fiber assembly may additionally include the temperature resistant layer 156, for example, a silicone or polyimide coating, disposed on or around the protective layer 155. The temperature resistance layer 156 may have a thickness in a range of about 0.01 mm to about 3.0 mm, inclusive. The fiber encapsulation layer 154 of the G.652.D optical fiber assembly 150 may also include the jacket 157 disposed on the temperature resistant layer 156. The jacket 157 may be formed from may be formed from PEEK or any other suitable material described herein, and may have a thickness in a range of about 80 μm to about 3,000 μm, inclusive. In some embodiments, including the temperature resistant layer 156 and/or the jacket 157 may reduce the micro-bending loss of the G.652.D optical fiber assembly 150 to be equal to or less than 5 dB/km.

In some embodiments, the optical fiber assembly 150 may be configured to transmit optical communication signals (e.g., internet signals, cable signals, telecom signals, etc.), and may configured as fiber-to-home cables. In some embodiments, the optical fiber sensing assembly 150 may be configured to measure various operating parameters of the conductor 100, for example, mechanical parameters such as strain (e.g., distributed strain), stress, sag, change in length, etc., or temperature (e.g., distribute temperature), or electrical operating parameters (e.g., detect line faults or breaks). For example, a signal generator may be used to communicate optical energy (e.g., a continuous or pulsed laser light) with wavelength (Xo) into the fiber core 152, and analyze the returning optical energy (e.g., Raman back scattering light or Brillouin back scattering light) from the same fiber core 152 to obtain precise temperature (T) and strain (E) profile along the conductor 100 in real-time.

In some embodiments, time of flight measurements may be used to determine the conductor length for precise line sag information or line fault location real time. When optical energy (e.g., laser light) propagates inside the fiber core 152, it may interact with the material which forms the fiber core 152 and generate Raman scattering light and Brillouin scattering light. The power intensity of anti-stock Raman Back Scattering light is sensitive only to fiber's temperature change, therefore the intensity ratio between anti-stokes and stokes peaks is used to calculate the temperature (T) variation. Detection of wavelength change of Brillouin back scattering light can be used to measure both temperature (T) and strain (e) of the fiber. In some embodiments, the optical fiber assembly 150 may be able to sense various parameters of the conductor 100 or surroundings thereof using optical time domain reflectometry (OTDR), distributed temperature sensing (DTS), distributed strain sensing (DSS), and/or distributed acoustic sensing (DSS).

In some embodiments, the optical fiber assembly 150 may be configured to sense or monitor vibration in the conductor 100 or in the air surrounding the conductor 100. In some embodiments, the optical fiber assembly 150 may be configured to sense aeolian vibrations that are high frequency and low amplitude vibrations, and/or sense galloping vibrations that are low frequency and high amplitude vibrations. Aeolian vibrations may correspond to wind speeds of less than about 8 m/s, and ability to sense aeolian vibrations may enable the optical fiber assembly 150 to sense wind speed. Moreover, galloping vibrations may correspond to wind speeds of equal to or greater than about 10 m/s, and ability to sense these vibrations may allow determination of high winds around the conductor 100, which can damage the conductor 100 or may be indicators of a hazardous weather. In some embodiments, the optical fiber assembly 150 may be configured to monitor vibrations in the range of about 2 m/s to about 50 m/s range, that may enable monitoring vibrations in a portion or sub-span of the conductor 100. In some embodiments, 5 or more optical fiber assemblies 150 may be included in the conductor 100 that are collectively used for vibration monitoring.

As previously described, conventional conductors include optical fiber sensors that may be stranded on the conductor or disposed within a separate tube (e.g., a hollow stainless steel or aluminum tube) that is co-located with various conductor layers of such conventional conductors. These conventional configurations are “loose” configurations” that do not allow the optical fibers to be in intimate contact with the various conductor layers of such conventional conductors which inhibits such optical fiber sensors from being able to measure mechanical properties (e.g., sab, change in length, strain, etc.) of such conventional conductors. In contrast, the optical fiber assembly 150 may be disposed in the core 112 such that the optical fiber assembly 150 is in intimate contact with the core 112. Because of this intimate contact, any mechanical stress, strain, sag, and/or change in length of the conductor 100 is also experienced by the optical fiber assembly 150, thus allowing the optical fiber assembly 150 to accurately measure changes in mechanical operating parameters. Moreover, the intimate contact also allows accurate measurement of conductor temperature (e.g., to allow detection and inhibit overheating of the core 112 above the first glass temperature) and/or to environmental temperature, for example, to enable monitoring of temperature anomalies in the environment around the conductor, for example, to detect hot spots, cold spots, heatwaves, wildfires, winter storms, etc.

As described herein in more detail, the core 112 with the optical fiber assembly 150 disposed therein may be formed by heating the composite core material to a forming temperature that may about equal to or above the first glass transition temperature or melting temperature of the core 112, or the processing temperature of the strength member, as previously described herein. The heated core material may be then molded, pulled, pultruded, or extruded along with the optical fiber assembly 150 (and optionally, along with the encapsulation layer 114) so as to form the core 112 (or otherwise, the strength member 110) with the optical fiber assembly 150 disposed or embedded in the core 112, and being in intimate contact with the core 112. Jackets used in conventional optical fibers have a glass transition temperature or melting temperature that is similarly to or lower than the first glass transition temperature or melting temperature, or processing temperature, such that the jackets of such conventional optical fibers would be damaged during the manufacturing process. In contrast, the second glass transition temperature or melting temperature or melting temperature of the fiber encapsulation layer 154 (e.g., the temperature resistant layer 156 and/or the jacket 157) of the optical fiber assembly 150 is greater than the first glass transition temperature or melting temperature such that heating of the composite material during forming of the core 112 does not damage the fiber encapsulation layer 154. Thus, the optical fiber assembly 150 can be disposed in, embedded in, or integrated into the core 112 while damage to the fiber encapsulation layer 154 is inhibited due to its higher second glass transition temperature or melting temperature. Moreover, the fiber encapsulation layer 154 may include one or more layers configured to reduce micro-bending induced transmission losses, as previously described herein.

While FIG. 1A shows the core 112 including a single optical fiber assembly 150, in some embodiments, a plurality of optical fiber assemblies 150 may be disposed in the core 112. In some embodiments, the one or more optical fiber assemblies 150 may be loosely packed inside the composite core 112 such that it is strongly bonded to the composite material of the core 112, but the loose packing beneficially reduces micro-bending of optical fibers.

In some embodiments, the composite core 112 may have a first color and the fiber encapsulation layer 154 (e.g., an outer jacket layer of the fiber encapsulation layer 154) may have a second color different from the first color. For example, the composite material used to form the core 112 may include carbon fibers, graphene, graphite, or some other reinforcing material that has a dark color such that the first color may be a dark color (e.g., black or near black color). In such embodiments, it may be difficult for a user installing the conductor 100 and desiring to access the optical fiber assembly 150 disposed within the core 112, to visually differentiate the optical fiber assembly 150 from the dark background provided by the core 112. To allow the user to easily differentiate the optical fiber assembly 150 from the core 112 material, the second color of the fiber encapsulation layer 154 may have a high contrast relative to the core 112. For example, the fiber encapsulation layer 154 may have a bright color such as white, bright pink, bright green, bright orange, bright blue, or any other suitable color that has a substantially high contrast with the color of the core 112. In some embodiments, the fiber encapsulation layer 154 may include a fluorescent material or include a fluorescent dye (e.g., nanoparticles, quantum dots, Eosin yellow, luminol, fluorescein, coumarin, cyanine, rhodamine, acridine orange, malachite green, zinc sulfide, any other suitable fluorescent material or a combination thereof) that may allow a user to visually differentiate the optical fiber assembly 150 from the core 112 (e.g., by shining a suitable excitation light on the core 112 so as to cause the fiber encapsulation layer 154 to fluoresce). In some embodiments, the fiber encapsulation layer 154 may include a phosphorescent material (e.g., phosphorous).

The optical fiber assembly 150 may be disposed at any suitable location in the core 112. In some embodiments, the optical fiber assembly 150 may be disposed approximately along a central axis of the strength member 110, or a central axis of the conductor 100 in embodiments in which the conductor 100 has a single strength member 110.

As previously described, micro-bending is usually caused by external mechanical stresses against the cable material that compress the optical fiber, or may be due to actual bending of the strength member 110 during. For example, the micro-bending may be caused in the optical fiber assembly 150 during manufacturing of the strength member 110 (e.g., pultruding or extruding of the composite core 112 along with the optical fiber assembly 150 disposed therein), deliberate bending of the conductor 100 (e.g., due to coiling of the conductor 100 in a spool), or during operation of the conductor 100 (e.g., due to tensile stresses, sag, or compressive stresses caused by temperature changes or accumulation of dirt, dust, snow, or ice on the conductor 100). Micro-bending can result in random, high-frequency perturbations in the optical fiber assembly 150 that can cause signal transmission losses. Micro-bending stresses will generally be the smallest at or proximate to the central axis of the core 112. Thus, locating the optical fiber assembly 150 along the central axis of the core 112 may reduce the micro-bending stresses on the optical fiber assembly 150, thereby reducing optical energy transmission losses.

In some embodiments, the optical fiber assembly 150 may have a micro-bending induced optical energy transmission loss of at least about 5.0 dB/km, at least about 4.8 dB/km, at least about 4.5 dB/km, at least about 4.2 dB/km, at least about 4.0 dB/km, at least about 3.8 dB/km, at least about 3.5 dB/km, at least about 3.2 dB/km, at least about 3.0 dB/km, at least about 2.8 dB/km, at least about 2.5 dB/km, at least about 2.2 dB/km, at least about 2.0 dB/km, at least about 1.8 dB/km, at least about 1.5 dB/km, at least about 1.2 dB/km, at least about 1.0 dB/km, at least about 0.8 dB/km, at least about 0.6 dB/km, at least about 0.4 dB/km, at least about 0.2 dB/km, or at least about 0.1 dB/km. In some embodiments, the optical fiber assembly 150 has a micro-bending induced optical energy transmission loss of no more than about 30 dB/km, no more than about 28 dB/km, no more than about 25 dB/km, no more than about 22 dB/km, no more than about 20 dB/km, no more than about 18 dB/km, no more than about 15 dB/km, no more than about 12 dB/km, no more than about 10 dB/km, no more than about 8 dB/km, no more than about 5 dB/km, no more than about 3 dB/km, no more than about 2 dB/km, no more than about 1 dB/km, no more than about 0.5 dB/km, no more than about 0.1 dB/km, or no more than about 0.05 dB/km. Combinations of the above-referenced micro-bending induced losses are also possible (e.g., at least about 0.1 dB/km and no more than about 4.5 dB/km or at least about 5 dB/km and no more than about 30 dB/km), inclusive of all values and ranges therebetween.

In some embodiments, the optical fiber assembly 150 has a micro-bending induced optical energy transmission loss between about 0.2 dB/km and about 20 dB/km, about 0.2 dB/km and about 15 dB/km, about 0.2 dB/km and about 10 dB/km, about 0.2 dB/km and about 5 dB/km, about 0.2 dB/km and about 4 dB/km, about 0.2 dB/km and about 3 dB/km, about 0.2 dB/km and about 2 dB/km, or about 0.2 dB/km and about 1.0 dB/km.

In some embodiments, the optical fiber assembly 150 has a bend radius of at least about 20 mm, at least about 19 mm, at least about 18 mm, at least about 17 mm, at least about 16 mm, at least about 15 mn, at least about 14 mm, at least about 13 mm, at least about 12 mm, at least about 11 mm, at least about 10 mm, at least about 9 mm, at least about 8 mm, at least about 7 mm, at least about 6 mm, at least about 5 mm, at least about 4 mm, at least about 3 mm, or at least about 2 mm such that the optical fiber assembly 150 has a micro-bending induced optical energy transmission loss of at equal to or less than about 5.0 dB/km. In some embodiments, the optical fiber assembly 150 has a bend radius of no more than about 40 mm, no more than about 38 mm, no more than about 35 mm, no more than about 32 mm, no more than about 30 mm, no more than about 28 mm, no more than about 25 mm, no more than about 22 mm, no more than about 20 mm, no more than about 18 mm, no more than about 15 mm, no more than about 12 mm, no more than about 10 mm, no more than about 9 mm, no more than about 8 mm, no more than about 7 mm, no more than about 6 mm, or no more than about 5 mm. Combinations of the above-referenced bend radius values also possible (e.g., at least about 6 mm and no more than about 15 mm or at least about 5 mm and no more than about 10 mm), inclusive of all values and ranges therebetween. Using an optical fiber assembly 150 that has a low micro-bending induced optical energy transmission loss advantageously allows positioning of the optical fiber assembly 150 at any suitable location in the core 112, for example, offset from the central-axis or proximate to an radially outer edge of the core 112, as described herein.

In some instances, it may be desirable to enable a user to easily access the optical fiber assembly 150 disposed or embedded in the core 112. For example, in some instances a user or worker may need to remove at least a portion of the conductor layer 120, the encapsulation layer 114, and the core 112 to gain access to the optical fiber assembly 150 to allow routing and coupling of the optical fiber assembly 150 to a controller (e.g., the controller 570 as described in further detail herein), or for splicing the optical fiber assembly 150 with an optical fiber assembly of another conductor. It may be difficult for the user to gain access to or visually identify the optical fiber assembly 150 if it is located or buried deep within the core 112. In some embodiments, the optical fiber assembly 150 may be disposed proximate to a radially outer edge of the core 112. In other words, the optical fiber assembly 150 may be disposed parallel to the central axis of the core 112 proximate to an outer peripheral edge of the core 112. This may allow the user to easily access the optical fiber assembly 150 by removing only a small portion of the core 112 proximate to a radially outer edge of the core 112.

In some embodiments, a shortest radial distance from an outer edge of optical fiber assembly 150 to a proximate radial outer edge of the core 112 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive). In some embodiments, the shortest radial distance may be at least 0.1 mm. In some embodiments, the shortest radial distance may be at least 0.2 mm. In some embodiments, the shortest radial distance may be at least 0.3 mm. In some embodiments, the shortest radial distance may be at least 0.4 mm. In some embodiments, the shortest radial distance may be at least 0.5 mm. In some embodiments, the shortest radial distance may be at least 0.6 mm. In some embodiments, the shortest radial distance may be at least 0.7 mm. In some embodiments, the shortest radial distance may be at least 0.8 mm. In some embodiments, the shortest radial distance may be at least 0.9 mm. In some embodiments, the shortest radial distance may be at least 1.0 mm. In some embodiments, the shortest radial distance may be at least 1.2 mm. In some embodiments, the shortest radial distance may be at least 1.4 mm. In some embodiments, the shortest radial distance may be at least 1.6 mm. In some embodiments, the shortest radial distance may be at least 1.8 mm. In some embodiments, the shortest radial distance may be at least 2.0 mm. In some embodiments, the shortest radial distance may be at least 2.2 mm. In some embodiments, the shortest radial distance may be at least 2.4 mm. In some embodiments, the shortest radial distance may be at least 2.6 mm. In some embodiments, the shortest radial distance may be at least 2.8 mm. In some embodiments, the shortest radial distance may be at least 3.0 mm.

In some embodiments, the shortest radial distance may be at most 3 mm. In some embodiments, the shortest radial distance may be at most 2.8 mm. In some embodiments, the shortest radial distance may be at most 2.6 mm. In some embodiments, the shortest radial distance may be at most 2.4 mm. In some embodiments, the shortest radial distance may be at most 2.2 mm. In some embodiments, the shortest radial distance may be at most 2.0 mm. In some embodiments, the shortest radial distance may be at most 1.9 mm. In some embodiments, the shortest radial distance may be at most 1.8 mm. In some embodiments, the shortest radial distance may be at most 1.7 mm. In some embodiments, the shortest radial distance may be at most 1.6 mm. In some embodiments, the shortest radial distance may be at most 1.5 mm. In some embodiments, the shortest radial distance may be at most 1.4 mm. In some embodiments, the shortest radial distance may be at most 1.3 mm. In some embodiments, the shortest radial distance may be at most 1.2 mm. In some embodiments, the shortest radial distance may be at most 1.1 mm. In some embodiments, the shortest radial distance may be at most 1.0 mm.

The optical fiber assembly 150 may thus be used to measure conductor length of the conductor 100 for measuring precise sag in the monitored circuit real time accuracy. The sag determination may be independent of environmental condition. The conductor length may also be useful to determine a fault location in the conductor 100 when necessary for prompt dispatch of crew to the exact fault location. Accurate distributed temperature sensing may allow for monitoring of surrounding areas such as wildfires or winter storm, as well as hot spots (e.g., partial conductor damage from broken strands) and cold spots (e.g., vegetation accidents with tree onto the conductor). Determination of the strain profile along conductor length of the conductor 100 may allow for accurate monitoring of snow or ice accumulation to enable proactive remediation (e.g., ice melting) and storm restoration. Such information may allow a controller (e.g., a power grid control room) to monitor the conductor 100 operation in real time with confidence and reliability.

The encapsulation layer 114 is disposed around the core 112, for example, circumferentially around the core 112. In some embodiments, an inner insulation layer (not shown) may optionally be interposed between the core 112 and the encapsulation layer 114. The inner insulation layer may be formed from any suitable insulative material, for example, glass fibers (disposed either substantially parallel to axial direction or woven or braided glass), a resin layer, an insulative coating, any other suitable insulative material or a combination thereof. In some embodiments, the inner insulation layer may also be disposed on axial ends of the core 112, for example, to protect the axial ends of the core 112 from corrosive chemicals, environmental damage, etc.

The encapsulation layer 114 may be formed from any suitable electrically conductive or non-conductive material. In some embodiments, the encapsulation layer 114 may be formed from a conductive material including, but not limited to aluminum (e.g., 1350-H19), annealed aluminum (e.g., 1350-0), aluminum alloys (e.g., Al—Zr alloys, 6000 series Al alloys such 6201-TS1, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof. In some embodiments, the encapsulation layer 114 is formed from Al and is pretensioned, i.e., is under tensile stress after being disposed on the core 112. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 114 may be disposed on the core 112 using any suitable process. In some embodiments, the encapsulation process 114 for disposing the encapsulation layer 114 around the core 112 may employ a conforming machine. For example, the encapsulation process may be performed with a similarly functional machine other than a conforming machine, and be optionally further drawn to achieve target characteristics of the encapsulation layer 114 (e.g., a desired geometry or stress state). The conforming machines or the similar machines used for disposing the encapsulation layer 114 may allow quenching of the encapsulation layer 114. The conforming machine may be integrated with stranding machine, or with pultrusion machines used in making fiber reinforced composite strength members. While FIG. 1A shows a single encapsulation layer 114 disposed around the core 112, in some embodiments, multiple encapsulation layers 114 may be disposed around the core 112. In such embodiments, each of the multiple encapsulation layers 114 may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pretensioned or precompressed aluminum.

In some embodiments, the interface between the core 112 and the encapsulation layer 114 may include surface features, for example, grooves, slots, notches, indents, detents, etc. to enhance adhesion, bonding and/or interfacial locking between a radially outer surface of the core 112 and a radially inner surface of the encapsulation layer 114. Such surface features may facilitate retention and preservation of the stress from pretensioning in the encapsulation layer 114. In some embodiments, the composite core 112 may have a glass fiber tow disposed around its outer surface to create a screw shape or twisted surface. In some embodiments, a braided or woven fiber layer is applied in the outer layer of the core 112 to promote interlocking or bonding between the core 112 and the encapsulation layer 114.

In some embodiments, the encapsulation layer 114 may have a thickness in a range of about 0.3 mm to about 5 mm, inclusive, or even higher (e.g., 0.3, 0.5, 1, 1.5, 2.0, 2.5, 3.0, 3.5, 4.0, 4.5, 5.0 mm, inclusive, or even higher). In some embodiments, a ratio of an outer diameter of the encapsulation layer 114 to an outer diameter of the core 112 is in range of about 1.2:1 to about 5:1, inclusive (e.g., 1.2:1, 1.5:1, 2:1, 2.5:1, 3:1, 3.5:1, 4:1, 4.5:1, or 5:1, inclusive).

In some embodiment, the strength member 110 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa). In some embodiments, the elongation during pretension of the strength member 110 may include elongation by at least 0.01% strain (e.g., at least 0.01%, at least 0.05%, at least 0.1%, at least 0.15%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 110 may be pre-tensioned before or after entering the conforming machine. Moreover, the strength member 110 may be configured to endure radial compression from crimping of conventional fittings as well as radial pressure during conforming of drawing down process or folding and molding of at least 3 kN (e.g., at least 3, at least 4, at least 5, at least 10, at least 15, at least 20, or at least 25 kN, inclusive), for example for composite cores 112 with little to substantially no plastic deformation.

In some embodiments, the encapsulation layer 114 may have an outer surface that is configured to be smooth and shiny (e.g., surface treated) so as to reduce absorptivity (i.e., enhance solar reflectivity) so as to reduce an operating temperature of the core 112 and to prevent the temperature of the core 112 from exceeding its glass transition temperature or melting temperature or melting point. As described in further detail herein, the outer coating 130 may be formulated to have high radiative emissivity in the 2.5 microns to 15 microns wavelength, inclusive of the solar radiation. While this may cause cooling of the conductor layer 120, the radiated heat will also travel towards the strength member 110 and cause heating of the core 112, for example, cause the core 112 to be at a higher operating temperature than the conductor layer 120, which is undesirable. To reduce absorption of this emitted radiation, the outer surface of the encapsulation layer 114 may be sufficiently reflective so as to have solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, or 15 microns, inclusive), at an operating temperature of the conductor 100 in a range of 90 degrees Celsius to 250 degrees Celsius, inclusive (e.g., 90, 100, 120, 140, 160, 180, 200, 220, 240, or 250 degrees Celsius, inclusive).

In some embodiments, the outer surface of the encapsulation layer 114 is optionally, at least one of treated or coated with a coating (e.g., the inner coating 116) so as to have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. In some embodiments, the outer surface of the encapsulation layer 114 may be surface treated (e.g., plasma treated, texturized, etc.) to have the solar absorptivity as described above.

In some embodiments, the strength member 110, i.e., the outer surface of the encapsulation layer 114 may be optionally coated with an inner coating 116 to reduce solar absorptivity. For example, the inner coating 116 may be disposed between the encapsulation layer 114 and the conductor layer 120. In some embodiments, the inner coating 116 may be formulated to have an absorptivity of less than 0.6 (e.g., less than 0.6, less than 0.55, less than 0.5, less than 0.45, less than 0.4, less than 0.35, less than 0.3, less than 0.25, less than 0.2, less than 015, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11.0, 12.0, 13.0, 14.0, or 15.0 microns, inclusive), at an operating temperature of the conductor 100 in a range of 90 degrees Celsius to 250 degrees Celsius, inclusive (e.g., 90, 100, 120, 140, 160, 180, 200, 220, 240, or 250 degrees Celsius, inclusive). The inner coating 116 may be configured to reflect a substantial amount of solar radiation in the wavelength of equal to or less than 2.5 microns (e.g., at least 50% of solar radiation in a wavelength of equal to or less than 2.5 microns that is incident on the encapsulation layer 114). In some embodiments, a thickness of the inner coating 116 may be in a range of about 1 micron to about 500 microns, inclusive (e.g., 1, 5, 10, 20, 30, 40, 50, 60, 70, 80, 90, 100, 150, 200, 250, 300, 350, 400, 450, or 500 microns, inclusive).

In some embodiments, the inner coating 116 may have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. As previously described, the strength member 110 may include a composite core 112 that may be black in color (e.g., includes a carbon composite). The core 112 may therefore, act as a black body absorbing radiation causing the core 112 to have a higher temperature relative to the conductor layer 120 or otherwise, the encapsulation layer 114. This may further reduce an upper limit of the operating temperature of the conductor 100 by up to 10 degrees Celsius, thus constraining the ampacity of the conductor 100. In contrast, the encapsulation layer 110 having the highly reflective outer surface, and/or the inner coating 116 having low solar absorptivity reflect a substantial portion of the heat emitted by the conductor layer 120 back into the environment. This may facilitate lowering an operating temperature of core 112, therefore protecting the core 112 and allowing the conductor 100 to operate at a higher temperature relative to the core 112 so as to inhibit the temperature of the core 112 from exceeding a threshold temperature (e.g., its glass transition temperature or melting temperature or melting point). In some embodiments, the inner coating 116 may include any inner coating having any suitable structure and function as described in detail in U.S. patent application Ser. No. 18/189,726, filed Mar. 24, 2023, and entitled “Composite Conductors Including Radiative and/or Hard Coatings and Methods of Manufacture,” (the “'726 application”) the entire disclosure of which is incorporated herein by reference.

The conductor layer 120 is disposed around the strength member 110 and configured to transmit electrical signals therethrough at an operating temperature in a range of 60 degrees to 250 degrees Celsius, inclusive. In some embodiments, the conductor layer 120 may include a plurality of strands of a conductive material disposed around the strength member 110. For example, the conductor layer 120 may include a first set of conductive strands disposed around the strength member 110 in a first wound direction (e.g., wound helically around the strength member 110 in a first rotational direction), a second set of conductive strands disposed around the first set of strands in a second wound direction (e.g., wound helically around the first set of conducive strands in a second rotational direction opposite the first rotational direction), and may also include a third set of strands wound around the second set of strands in the first wound direction, and may further include any number of additional strands as desired.

In some embodiments, the conductor layer 120 (e.g., a plurality of strands of conductive material) may include, for example, aluminum, aluminum alloy, copper or copper alloy including micro alloy as conductive media, etc. In some embodiments, the conductor layer 120 may include conductive strands including Z, C or S wires to keep the outer strands in place. The conductor layer 120 may have any suitable cross-sectional shape, for example, circular, triangular, trapezoidal, etc. In some embodiments, the conductor layer 120 may include a stranded aluminum layer that may be round or trapezoidal. In some embodiments, the conductor layer 120 may include Z shaped aluminum strands. In some embodiments, the conductor layer 120 may include S shaped aluminum strands. In some embodiment, the conductor 100 may include any of the conductors described in U.S. Pat. No. 9,633,766, filed Sep. 23, 2015, and entitled “Energy Efficient Conductors with Reduced Thermal Knee Points and the Method of Manufacture Thereof,” the entire disclosure of which is incorporated herein by reference.

In some embodiments, the strength member 110 may be adequately tensioned while the conductor layer 120 of aluminum or copper or their respective alloys disposed around the strength member 110 may be applied to cause the conductor 100 to form a cohesive conductive hybrid rod that is spoolable onto a conductor reel. In some embodiments, to facilitate conductor spooling onto a reel and conductor spring back at ease, the conductor 100 may be optionally configured to be non-round (e.g., elliptical) such that the shorter axis (in conductor 100) is subjected to bending around a spool (or a sheaves wheel during conductor installation) to facilitate a smaller bend or spool radius, while the strength members 110 may be configured to have a longer axis to facilitate spring back for installation. The overall conductor 100 may be round with non-round strength member 110 or multiple strength members 110 arranged to be non-round, and the spooling bending direction may be along the long axis of the strength member 110 to facilitate spring back while not overly subjecting the conductor layer 120 with additional compressive force from spooling bending.

To further facilitate spooling of the conductor layer 120 on the strength member 110, in some embodiments, the conductor layer 120 may include multiple segments, for example, strands or sets of strands or wires of conductive material (e.g., 2, 3, 4 etc.), and each segment bonded to strength member 110 while retaining compressive stress, and the segments rotates one full rotation or more along the conductor 100 length (equal to one full spool in a reel) to facilitate easy spooling. Thus, the conductor 100 may be configured to have negligible skin effect (i.e., conducting layer thickness is less than the skin depth required at AC circuit frequency), with the strength member 110 may be under sufficient residual tensile stress, and the conductor layer 120 (e.g., each of the strands of the conductive material) are mostly free of tension or under compressive stress. In some embodiments, the strands of the conductive material may be formed from a conforming machine, for example, by extruding hot deformable (e.g., semi solid) conductive material (e.g., aluminum) from a mold. The strands can be molded to be round or trapezoidal. In some embodiments, the extrusion mold or die may have a stranding lay ratio defined therein so that during the stranding operation of the conductive strands, no shaping may be needed (e.g., removing of sharp corners or edges of the conductive strands to avoid corona as is performed in conventional stranding operations). In some embodiments, the conductive media may be extruded out of the mold or die at an angle so as to form conductive strands that wrap around the strength member 110 at an angle, as described herein.

In some embodiments, for AC applications where skin effect is prominent, the conductor layer 120 may include a plurality of layers of conductive strands disposed concentrically around the strength member 110, with each layer being of finite thickness to maximize skin effect for lowest AC resistance at minimal conductor content. In some embodiments, the conductor layer 120 may be optionally stranded to facilitate conductor spooling around a reasonably sized spool and facilitate conductor stringing. In some embodiments, the outer most strands included in the conductor layer 120 may be TW, C, Z, S, or round strands if more aluminum or copper are used, as it will not cause permanent bird caging problem (i.e., the inner strands of the conductor layer 120 may not be deformed such that they prevent the outer strands from proper resettlement after tension is released or reduced). Accordingly, the smooth outer surface and the compact configuration can effectively reduce the wind load and ice accumulation on the conductor 100, resulting in less sag from ice or wind related weather events.

In some embodiments, the conductor 100 may be pre-stressed, for example, by subjecting the conformed conductor 100 to a paired tensioner approach or trimming the predetermined core 112 length before dead-ending, all accomplished without exerting the high tensile stress to the pole arms to pre-tension conventional conductors in the electric poles. For example, the conductor 100 may be subjected to pre-tensioning treatment using sets of bull wheels prior to the first sheave wheel during stringing operation, without exerting additional load to the electric towers. This can, for example, be accomplished by two sets of tensioners, with the first set maintaining normal back tension to the conductor drum/reel, while the second set restoring the normal stringing tension to avoid excessive load to electric poles or towers, for example, old towers in reconductoring projects.

The conductor 100 may be subjected to the pre-tensioning stress between the first and second tensioners, for example, about 2 times of the average conductor every day tensile load to ensure that the pre-tensioning is driving its knee point below the normal operating temperature so that conductor layer 120 is not in tension for optimal self-damping and the conductor 100 substantially does not change its sag with temperature. In some embodiments, the conductor layer 120 (e.g., each strand of conductive material included in the conductor layer 120) may include aluminum having electrical conductivity of at least 50% ICAS, at least 55% ICAS, at least 60% ICAS, or at least 65% ICAS, or may include copper having electrical conductivity of at least 65% ICAS, at least 75% ICAS, or even at least 95% ICAS.

The conductor 100 may combine pre-tensioning with strength member 110 that may include an encapsulation layer 114 formed of a conductive material of sufficient compressive strength and thickness to substantially preserve the pre-tensioning stress in the strength member 110, while rendering the conductor layer 120 disposed around the strength member 110 mostly tension free or in compression after conductor field installation, and preserving the low thermal expansion characteristics of the strength member 110. The conductor 100 may have an inherently lower thermal knee point. Unlike gap conductors requiring complicated installation tools and process, where the conductor, fitting, installation, and repair are very expensive, the conductor 100 may be easy to install and repair, while maintaining low sag, high capacity, and energy efficiency as a result of knee point shift.

In some embodiments, metallurgical bonding may be provided between the strength member 110 and the conductor layer 120. In some embodiments, adhesives (e.g., Chemlok 250 from Lord Corp) may be applied to the surface of the strength member 110 of the conductor 100 to further promote the adhesion between the strength member 110 and the conductor layer 120 disposed thereon. Additionally, surface features on the strength member 110 may be incorporated to promote interlocking between the conductor layer 120 and the strength member 110 (e.g., stranded strength member 110 such as multi-strand composite cores in C⁷ or steel wires in conventional conductors; pultruded composite core with protruding or depleting surface features; and an intentional rough surface on strength members such as ACCC core from CTC Global where a single or multiple strand glass or basalt or similar and other types of insulating material were disposed around the strength member 110, instead of just longitudinally parallel configuration described patent). In some embodiments, the conductor layer 120 may include aluminum, aluminum alloy, copper and copper alloys, lead, tin, indium tin oxide, silver, gold, nonmetallic materials with conductive particles, any other conductive material, conductive alloy, or conductive composite, or combination thereof.

It should be appreciated that, the conductor layer 120 may be under no substantial tension while the strength member 110 may be pre-stretched/tensioned. After the pre-tension in the strength member 110 is released, the conductor layer 120 may be subjected to compression, which may minimize the shrinking back of the strength member 110. The strength member 110 made with composite materials may have a strength above 80 ksi, and a modulus ranging from 5 msi to 40 msi, and a CTE of about 1×10⁻⁶/° C. to about 8×10⁻⁶/° C., inclusive.

The level of pre-tensioning in the conductor 100 may be dependent on conductor size, conductor configuration, conductor application environment, and the desirable target thermal knee point. If the goal is to have a conductor thermal knee point at or near the stringing temperature (e.g., ambient), the tension desired onto the strength member 110 may only be about the same stringing sag tension (e.g., about 10% to about 20%, inclusive, of rated conductor strength), plus about 5% to about 50%, inclusive, of the stringing sag tension level (e.g., about 10% to about 30%, inclusive) extra to keep all aluminum included in the conductor layer 120 (or copper in the case of copper conductors) free of tension after stringing, which is significantly lower compared to conductor pre-tensioning in the electric towers where a load about 40% of conductor tensile strength are commonly used. If lower thermal knee point is desired, higher pre-tensioning stress may be used. It is also important to note that the composite core 112 of the strength member 110 may include carbon fibers that are strong, light weight, and have low thermal sag. The encapsulated strength member 110 using fiber reinforced composite materials may be particularly advantageous where the elastic strength member 110 facilitates spring back of the encapsulated strength member 110 from the reeled configuration for field installation. In some embodiments, the strength member 110 may be pre-strained by at least 0.05% (e.g., at least 0.05%, at least 0.1%, at least 0.15%, at least 0.2%, at least 0.25, or at least 0.3%, inclusive).

In some embodiments, for example, for AC transmission applications, the conductor layer 120 may include concentric layers (e.g., strands) of conductive media disposed around the strength member 110 during a conforming process. The skin depth may be adjusted based on transmission frequency. In some embodiments, the skin depth may be in a range of about 6 mm to about 12 mm, inclusive at 60 Hz (e.g., 6, 7, 8, 9, 10, 11, or 12 mm, inclusive), or in a range of about 12 mm to about 20 mm, inclusive at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive). A thickness of each strand of conductive media included in the conductor layer 120 may be less than the maximum allowable depth, for example, to achieve low A/C resistance. In some embodiments, each of the conductive strands included in the conductor layer 120 may include copper having a thickness of up to 12 mm (e.g., up to 12, up to 11, up to 10, up to 9, or up to 8 mm, inclusive). In some embodiments, each of the conductive strands included in the conductor layer 120 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 120.

In some embodiments, an interface between the strength member 110 and the conductor layer 120 may be further optimized with surface features in the strength member 110 enhancing interfacial locking and/or bonding between the strength member 110 and the conductor layer 120 to retain and preserve the stress from pretensioning. Such features may include, but are not limited to protruded features on an outer surface of the strength member 110 (e.g., and outer surface of the encapsulation layer 114 of the inner coating 116) as well as rotation of the strength member 110 around the axial direction. Furthermore, the same features can be incorporated into the interface between subsequent conductive strands included in the conductor layer 120. In some embodiments, the strength member 110 may include a glass fiber tow disposed around its surface to create a screw shape or twisted surface. In some embodiments, a braided or woven fiber layer is applied in the outer layer of the strength member 110 to promote interlocking or bonding between strength member 110 and the conductor layer 120. Steel wires may be shaped with similar surface features. In some embodiments, the strength member 110 may be pretensioned by pretensioning the reinforcement fibers in a matrix of conductive media such as aluminum or copper or their respective alloys. Such reinforcement fibers may include ceramic fibers, non-metallic fibers, carbon fibers, glass fibers, and/or others of similar types.

In some embodiments, an insulating layer 122 (e.g., a jacket) may optionally be disposed around the conductor layer 120. The insulating layer 122 may be formed from any suitable electrically insulative material, for example, rubber, plastics, or polymers (e.g., polyethylene, PTFE, high density polyethylene, cross-linked high density polyethylene, etc.). The insulating layer 122 may be configured to electrically isolate or shield the conductor 100. In some embodiments, the insulating layer 122 may be excluded.

In some embodiments, an outer surface of the conductor layer 120 (e.g., outer surface of the outermost conductive strands or an outer surface of each of the conductive strands) or the insulating layer 122 is treated with features and/or include features to cause the outer surface to have a solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive). In some embodiments, the outer surface has a solar absorptivity of less than 0.55.

In some embodiments, to reduce the operating temperature of the conductor 100, the conductor 100 may also include an outer coating 130 disposed on the conductor layer 120. The outer coating 130 is formulated to have a solar absorptivity of less than 0.6 (e.g., less than 0.6, less than 0.55, less than 0.5, 1 less than 0.45, less than 0.40, less than 0.35, less than 0.30, less than 0.25, less than 0.20, less than 0.15, less than 0.1, inclusive or even lower) at a wavelength of less than 2.5 microns, and a radiative emissivity of greater than 0.5 (e.g., greater than 0.50, greater than 0.55, greater than 0.60, greater than 0.65, greater than 0.70, greater than 0.75, greater than 0.80, greater than 0.85, greater than 0.90, greater than 0.95, inclusive, or even higher) at a wavelength in a range of 2.5 microns to 15 microns, inclusive at an operating temperature in a range of 60 degrees C. to 250 degrees Celsius, inclusive. In some embodiments, the outer coating 130 is formulated to have radiative emissivity of greater than 0.55. For example, the coating 130 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius.

The low solar absorptivity of the outer coating 130 at a wavelength of less than 2.5 microns causes the outer coating 130 to reflect a substantial amount of solar radiation (e.g., greater than 50%, greater than 60%, greater than 70%, greater than 80%, greater than 90%, or even greater than 95% of the incident solar radiation) in the wavelength of less than 2.5 microns, thus reducing solar absorption and inhibiting increase in operating temperature of conductor 100. Moreover, the high radiative emissivity of the outer coating 130 at the wavelength in a range of 2.5 microns to 15 microns causes the outer coating 130 to emit heat being generated by the conductor 100 due to passage of current therethrough as photons, thus increasing radiation of heat away from the conductor 100 into the environment, further reducing the operating temperature of the conductor 100. In some embodiments, the outer coating 130 may cause a reduction in operating temperature of the conductor 100 at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive). Thus, the conductor 100 can be operated at a lower temperature at the same ampacity. Conversely, the ampacity of the conductor 100 may be increased at the same operating temperature, relative to a conductor that does not include the outer coating 130. In some embodiments, in which a coupler mechanism is crimped to an axial end of the conductor 100, for example, to couple the conductor 100 to another conductor, or a dead-end fitting for coupling the conductor 100 to a transmission pole or tower, etc., the outer coating 130 may also be coated on the such fittings, couplers, or tension hardware, such as for example, dead-end couplers, splice couplers, suspension clamps, or any other suitable fittings or couplers to keep the temperatures of such fittings as low as possible and extend the life thereof.

In some embodiments, an outer surface of at least a portion of the conductive strands forming the conductor layer 120 may be cleaned, for example, using surfactants or solvents to provide a clean surface for depositing the outer coating 130. In some embodiments, the outer surface of the conductor layer 120 (e.g., each of the strands forming the conductor layer 120, the outer most strands, or an outer surface of the outer most strands) or the insulating layer 122 may be roughened by sand blasting to provide a rough surface to facilitate adhesion of the outer coating 130 thereto. In some embodiments, the base coat and/or the outer coating 130 may be hydrophobic, for example, to inhibit ice formation, inhibit fouling, protect against UV radiation, and inhibit water born dirt.

The outer coating 130 may be applied in the form of a paint or slurry using any suitable method, for example, painting, dipping, spraying, evaporation, deposition follow by curing or cross-linking, or shrink wrapping. In some embodiments, the outer surface of the conductor layer 120 (e.g., at least the outer most conductive strands included in the conductor layer 120) may be cleaned, for example, to remove oil, grease, lubricants, dirt etc., that may have deposited on the conductive strands during manufacturing of the conductive strands. The outer surface of the conductive strands of the conductor layer 120 may be cleaned using any suitable method such as, for example, via acid, solvents or using a mechanical means (e.g., sand blasted) to facilitate adhesion of the outer coating 130 to the outer surface of the conductor layer 120. In some embodiments in which the insulating layer 122 is disposed around the conductor layer 120, the outer surface of the insulating layer 122 may be cleaned or texturized (e.g., via sand blasting) before depositing the outer coating 130 thereon. The deposited outer coating 130 may be dried using hot air, infrared or naturally dried.

In some embodiments, the outer coating 130 may provide one or more benefits such as, for example, being transparent, being electrically conductive, having less curing time during coating, having high thermal aging resistance, having reduced dust accumulation, having corrosion resistance, being hydrophobic, having ice accumulation resistance, having weather resistance, having scratch and abrasion resistance, having wear resistance, having flame resistance, having self-healing properties, having reduced surface friction, having better recoatability, having a reduction in conductor pull forces, or any combination thereof. Additionally, the outer coating 130 can impart improvements in conductor lifespan and performance. Hydrophobic properties can mean that a water droplet on a coating can have a contact angle of about 90° or more. In some embodiments, hydrophobic properties can mean that a water droplet on a coating can have a contact angle of about 130 degrees or more Self-healing can be activated by exposure to one, or more conditions including normal atmospheric conditions, UV conditions, thermal conditions, or electric field conditions.

In some other embodiment, the outer coating 130 may be hydrophilic, that minimizes formation of water droplets as the contact angle is substantially less than 90 degree Such implementations may be particularly useful for reducing corona, especially for extremely high voltage (EHV) and/or ultrahigh voltage (UHV) applications where the voltage of the circuit can be above 200 kV.

In some embodiments, additionally or alternatively to the radiative and emissive properties described herein, the outer coating 130 may be a “hard coating” configured to have a hardness, cutting resistance, or erosion resistance that is at least 5% greater than a hardness, cutting resistance, or erosion resistance of aluminum or aluminum alloys. In this manner, the outer coating 130 may advantageously protect the conductor layer 120 (e.g., each of a plurality of conductive strands of the conductor layer 120) from erosion, cutting, or otherwise mechanical damage (e.g., from accidental cutting by kite strings). In some embodiments, the outer coating 130 may have an erosion resistance that is at least 5% greater than an erosion resistance of aluminum or aluminum alloys. In some embodiments, the outer coating 130 has a Vicker hardness of greater than 200 MPa. In some embodiments, the outer coating 130 may include any of the outer coatings as described in detail in the '726 application.

The conductor 100 including the optical fiber assembly 150 described herein are particularly suitable as underground conductors. The embedded optical fiber assembly 150 is shielded and protected by the core 112 for life, which protects the optical fiber assembly 150 from moisture damage and stress corrosion. Thus, the conductor 100 and the other conductors described herein are capable of distributed monitoring of conductor temperature, conductor strain, conductor discharge, earth movement at or near the underground conductor, as well as damage to the conductor 100. This is particularly beneficial for underground conductors where visual determination of faults is not possible until the conductors are dug up from the ground. Remote sensing provided by the optical fiber assembly 150 of the conductor 100 can allow determination of not only the fault sites with sufficient accuracy to allow repair teams to locate and perform maintenance on targeted locations reducing maintenance costs, the conductor 100 also allows prediction of ground movement and temperature. Thus, the conductor 100 may be used as sensors to detect earthquakes and wildfires, and locations thereof. Moreover, the conductor 100 including the optical fiber assembly 150 may also be used for vibration monitoring and can serve to detect and/or predict earthquakes.

The conductor 100 may improve sensing by providing more precise location identification of faults, for example, with a spatial resolution of equal to or less than about 25 cm, which is significantly better than conventional conductors. In some embodiments, the conductor 100 may provide a spatial resolution of about 25 cm. In some embodiments, the conductor 100 may provide a spatial resolution of equal to or less than about 15 cm. In some embodiments, the conductor 100 may provide a spatial resolution of equal to or less than about 12.5 cm. In some embodiments, the conductor 100 may provide a spatial resolution of equal to or less than about 11.0 cm. In some embodiments, the conductor 100 may provide a spatial resolution of equal to or less than about 10 cm. In some embodiments, the conductor 100 may provide a spatial resolution of equal to or less than about 9 cm. In some embodiments, the conductor 100 may provide a spatial resolution of equal to or less than about 8 cm. In some embodiments, the conductor 100 may provide a spatial resolution of equal to or less than about 7 cm. In some embodiments, the conductor 100 may provide a spatial resolution of equal to or less than about 6 cm. In some embodiments, the conductor 100 may provide a spatial resolution of equal to or less than about 5 cm. Such a high spatial resolution can enable fault location precise enough to minimize maintenance and repair activity and shortage outage time for repairs. Embedding the optical fiber assembly 150 in the core 112 of the conductor 100, which itself is encapsulated by the encapsulating layer 114, enhances optical fiber assembly 150 connectivity and/or life by inhibiting moisture ingress facilitating lifetime distributed sensing even in situations where the conductor 100 is compromised.

The conductor 100 (or any of the conductors described herein) allow for the optical fiber assembly 150 embedded therewithin to be spliced with optical fiber assemblies of other conductors with minimum crosstalk for connectivity. The conductor 100 can enable detection of wide range of data points, for example, along the entire length of the one or more conductor 100 included in underground transmission systems, thereby enhancing understanding of conductor 100 health and transient faults. Thus, the conductor 100 can enable precise fault location (e.g., using optical time domain reflectometry). Moreover, the conductor 100 can be capable of distributed sensing for temperature, strain, vibrations, and/or acoustic signals in the cable. In some implementations, the conductor 100 has temperature sensing resolution of at least about 0.01 degrees Celsius, and a strain resolution of at least about 1 micron. In some embodiments, the conductor 100 may provide a dynamic acoustic sensing range of at least about 120 dB, thus facilitating comprehensive data capture of the health or condition of the conductor 100 and the surroundings.

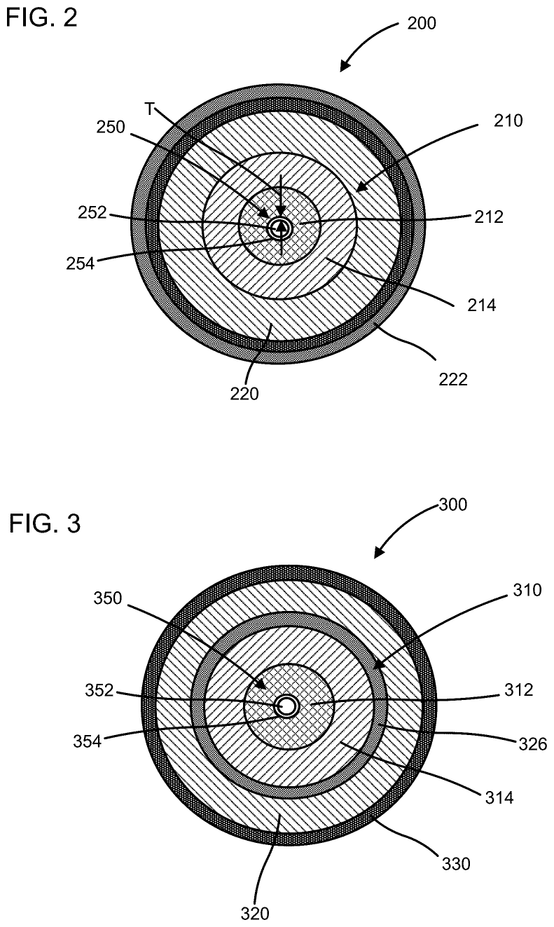

FIG. 2 is a side cross-section view of a conductor 200, according to an embodiment. The conductor 200 includes a strength member 210 including a core 212, an encapsulation layer 214 disposed around the core 212, and an optical fiber assembly 250 disposed in the core 21. The conductor 200 also includes a conductor layer 220, an outer coating 230, and may optionally, also include an insulating layer 222 disposed between the conductor layer 220 and the outer coating 230. The conductor 200 may be used in grid transmission applications to conduct electricity.

The strength member 210 includes a core 212 and an encapsulation layer 214 disposed circumferentially around the core 212. The core 212 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material may include a carbon fiber reinforced composite of a thermoplastic or thermoset resin. The reinforcement in the composite strength member 212 can be discontinuous such as whiskers or chopped fibers; or continuous fibers in substantially aligned configurations (e.g., parallel to axial direction) or randomly dispersed (including helically wind or woven configurations). In some embodiments, the composite material may include a continuous or discontinuous polymeric matrix composites reinforced by carbon fibers, glass fibers, quartz, or other reinforcement materials, and may further include fillers or additives (e.g., nanoadditives). In some embodiments, the core 212 may include a carbon composite including a polymeric matrix of epoxy resin cured with anhydride hardeners. In some embodiments, the core 212 may be include any material as described with respect to the core 112, and formed using any suitable mechanism or method as described with respect to the core 112.

As shown in FIG. 2, the core 212 is has a substantially circular cross-section, but may have any other suitable shape, as described with respect to the core 112. In some embodiments, the core 212 may have a diameter in a range of about 5 mm to about 15 mm, inclusive (e.g., 5, 6, 7, 8, 9, 10, 11, 12, 13, 14, or 15 mm, inclusive). In some embodiments, the core 212 may have a glass transition temperature or melting temperature or melting point of at least about 100 degrees Celsius (e.g., at least 100, at least 120, at least 140, at least 150, at least 160, at least 180, at least 200, at least 220, at least 240, at least 260, at least 280, or at least 300, degrees Celsius, inclusive), as previously described with respect to the core 112. In some embodiments, the core 212 may include any core as described in detail with respect to the core 112.

The encapsulation layer 214 is disposed circumferentially around the core 212. The encapsulation layer 214 may be formed from any suitable electrically conductive or non-conductive material. In some embodiments, the encapsulation layer 214 may be formed from a conductive material including, but not limited to aluminum (e.g., 1350-H19), annealed aluminum (e.g., 1350-0), aluminum alloys (e.g., Al—Zr alloys, 6000 series Al alloys such 6201-TS1, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof, as described with respect to the encapsulation layer 114. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 214 may be disposed on the core 212 using any suitable process. In some embodiments, the encapsulation process for disposing the encapsulation layer 214 around the core 212 includes using a conforming machine or stranding machine, or any other suitable process as described with respect to the encapsulation layer 114. While FIG. 2 shows a single encapsulation layer 214 disposed around the core 212, in some embodiments, multiple encapsulation layers 214 may be disposed around the core 212. In such embodiments, each of the multiple encapsulation layers 214 may be substantially similar to each other, or may be different from each other (e.g., formed from different materials, have different thicknesses, have different tensile strengths, etc.).

In some embodiments, the interface between the core 212 and the encapsulation layer 214 may include surface features, for example, grooves, slots, notches, indents, detents, etc. to enhance adhesion, bonding and/or interfacial locking between a radially outer surface of the core 212 and a radially inner surface of the encapsulation layer 214. Such surface features may facilitate retention and preservation of the stress from pretensioning in the encapsulation layer 214. In some embodiments, the composite core 212 may have a glass fiber tow disposed around its outer surface to create a screw shape or twisted surface. In some embodiments, a braided or woven fiber layer is applied in the outer layer of the core 212 to promote interlocking or bonding between the core 212 and the encapsulation layer 214.

In some embodiments, the encapsulation layer 214 may have a thickness in a range of about 0.25 mm to about 5 mm, inclusive, or even higher (e.g., 0.25, 0.3, 0.5, 1, 1.5, 2.0, 2.5, 3.0, 3.5, 4.0, 4.5, 5.0 mm, inclusive, or even higher). In some embodiments, a ratio of an outer diameter of the encapsulation layer 214 to an outer diameter of the core 212 is in range of about 1.2:1 to about 5:1, inclusive (e.g., 1.2:1, 1.5:1, 2:1, 2.5:1, 3:1, 3.5:1, 4:1, 4.5:1, or 5:1, inclusive).

In some embodiment, the strength member 210 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa, inclusive). In some embodiments, the elongation during pretension of the strength member 210 may include elongation by at least 0.005% strain (e.g., at least 0.005%, at least 0.01%, at least 0.1%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 210 may be pre-tensioned before or after entering the conforming machine. Moreover, the strength member 210 may be configured to endure radial compression from crimping of conventional fittings as well as radial pressure during conforming of drawing down process or folding and molding of at least 3 kN (e.g., at least 3 kN, at least 4 kN, at least 5 kN, at least 10 kN, at least 15 kN, at least 20 kN, or at least 25 kN, inclusive).

In some embodiments, the encapsulation layer 214 may have an outer surface that is smooth and shiny so as to maximize refractivity and reduce absorptivity (i.e., enhance reflectivity) for reducing an operating temperature of the core 212 and preventing the temperature of the core from exceeding its glass transition temperature or melting temperature. In some embodiments, the conductor 200 may include the outer coating 230 that is formulated to have a high radiative emissivity in the 2.5 microns to 15 microns wavelength, inclusive, of the solar radiation. While this may cause cooling of the conductor layer 220, the radiated heat will also travel towards the strength member 210 and cause heating of the core 212, for example, cause the core 212 to be at a higher operating temperature than the conductor layer 220, which is undesirable. In some embodiments in which there is no stranded layer of conductive materials around the encapsulation layer 214, the outer surface of the encapsulation layer 214 (e.g., an inner coating 216 disposed thereon) may be configured for high radiative emissivity to remove heat from conductor 200 through thermal radiation.

The conductor layer 220 is disposed around the strength member 210 and configured to transmit electrical signals therethrough at an operating temperature in a range of about 60 degrees to about 250 degrees Celsius, inclusive. In some embodiments, the conductor layer 220 may include a plurality of strands of a conductive material disposed around the strength member 210, as described with respect to the conductor layer 120. In some embodiments, the conductor layer 220 (e.g., a plurality of strands of conductive material) may include, for example, aluminum, aluminum alloy, copper or copper alloy including micro alloy as conductive media, etc. In some embodiments, the conductor layer 220 may include conductive strands including Z, C, or S wires to keep the outer strands in place. The conductor layer 220 may have any suitable cross-sectional shape, for example, circular, triangular, trapezoidal, etc. In some embodiments, the conductor layer 220 may include stranded aluminum layer that may be round or trapezoidal. In some embodiments, the conductor layer 220 may include Z shaped aluminum strands. In some embodiments, the conductor layer 220 may include S shaped aluminum strands. In various embodiments, the conductor layer 220 may be formed from any suitable material, as described with respect to the conductor layer 120.

In some embodiments, the strands of the conductive material of the conductor layer 220 may be formed using a conforming machine, for example, by extruding hot, deformable (e.g., semi solid) conductive material (e.g., aluminum) from a mold. The strands can be molded to be round or trapezoidal. In some embodiments, the conductive media may be extruded out of the mold or die at an angle so as to form conductive strands that wrap around the strength member 210 at an angle, as described herein. In some embodiments, the conductor layer 220 may include a plurality of layers of conductive strands disposed concentrically around the strength member 210. In some embodiments, the conductor layer 220 may be optionally stranded to facilitate conductor spooling around a reasonably sized spool and facilitate conductor stringing. In some embodiments, the outer most strands included in the conductor layer 220 may be TW, C, Z, S, or round strands, as previously described.

In some embodiments, the conductor 200 may be pre-stressed, as previously described with respect to the conductor 100. In some embodiments, the conductor layer 220 (e.g., each strand of conductive material included in the conductor layer 220) may include aluminum having electrical conductivity of at least 50% ICAS, at least 55% ICAS, at least 60% ICAS, or at least 65% ICAS, or may include copper having electrical conductivity of at least 65% ICAS, at least 75% ICAS, or even at least 95% ICAS. In some embodiments, metallurgical bonding may be provided between the strength member 210 and the conductor layer 220, for example, via an adhesive. In some embodiments, the conductor layer 220 may include aluminum, aluminum alloy, copper and copper alloys, lead, tin, indium tin oxide, silver, gold, nonmetallic materials with conductive particles, any other conductive material, conductive alloy, or conductive composite, or combination thereof. In some embodiments, a skin depth of the conductive strands included in the conductor layer 220 may be in a range of 6 mm to about 12 mm, inclusive at 60 Hz (e.g., 6, 7, 8, 9, 10, 11, or 12 mm, inclusive), or in a range of about 12 mm to about 20 mm, inclusive at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive). In some embodiments, each of the conductive strands included in the conductor layer 220 may include copper having a thickness of up to 12 mm (e.g., up to 12, up to 11, up to 10, up to 9, or up to 8 mm, inclusive). In some embodiments, each of the conductive strands included in the conductor layer 220 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 220.

In some embodiments, an insulating layer 222 (e.g., an outer jacket) may be disposed around the conductor layer 220, as shown in FIG. 2. The insulating layer 222 may be formed from any suitable electrically insulative material, for example, rubber, plastics, or polymers (e.g., polyethylene, high density polyethylene, cross-linked high density polyethylene, PTFE, etc.). The insulating layer 222 may be configured to electrically isolate or shield the conductor 200. In some embodiments, the insulating layer 222 may be excluded.

The outer coating 230 is disposed on an outer surface of the conductor layer 220, for example, around individual strands that form the conductor layer 220, or only on outer surface of the outer most conductive strands of the conductor layer 220. The outer coating 230 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees C. to 250 degrees Celsius, inclusive. For example, the coating 230 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius.

In some embodiments, additionally or alternatively to the radiative and emissive properties described herein, the outer coating 230 may be a hard coating configured to have a hardness, cutting resistance, or erosion resistance that is at least 5% greater than a hardness, cutting resistance, or erosion resistance of aluminum or aluminum alloys. In this manner, the outer coating 230 may advantageously protect the conductor layer 220 (e.g., each of a plurality of conductive strands of the conductor layer 220) from erosion, cutting, or otherwise mechanical damage (e.g., from accidental cutting by kite strings). In some embodiments, the outer coating 230 may have an erosion resistance that is at least 5% greater than an erosion resistance of aluminum or aluminum alloys. In some embodiments, the outer coating 230 has a Vicker hardness of greater than 200 MPa. In some embodiments, the outer coating 230 may be substantially similar to the outer coating 130 described with respect to FIG. 1A-1B or any outer coating described in detail in the '726 application.

The optical fiber assembly 250 is disposed in the core 212 and includes a fiber core 252 and a fiber encapsulation layer disposed around the fiber core 252. The fiber encapsulation layer 254 may have a second glass transition temperature or melting temperature that is greater than a first glass transition temperature or melting temperature of the core 252, or processing temperature of the strength member 210, as previously described herein. For example, the first glass transition temperature or melting temperature of the core 252 may be in a range of about 600 degrees Celsius to about 350 degrees Celsius, inclusive, and the second glass transition temperature or melting temperature may be in a range of about 80 degrees Celsius to about 450 degrees Celsius, inclusive. The fiber core 252 and the fiber encapsulation layer 254 may be substantially similar to the fiber core 152 and the fiber encapsulation layer 154, previously described in detail herein. In some embodiments, the fiber encapsulation layer 154 may include an outer moisture exclusion layer, or optical fiber assembly 250 may be disposed within an outer moisture exclusion layer, for example, the outer moisture exclusion layer 159, as previously described herein.

In some embodiments, the composite core 212 may have a first color and the fiber encapsulation layer 254 may have a second color different from the first color. For example, to allow the user to easily differentiate the optical fiber assembly 250 from the composite material, the second color of the fiber encapsulation layer 254 may have a high contrast relative to the core 212. For example, the fiber encapsulation layer 254 may have a bright color such as, for example, white, bright pink, bright green, bright orange, bright blue, or any other suitable color that has substantial contrast with the color of the core 212. In some embodiments, the fiber encapsulation layer 254 may include a fluorescent material or include a fluorescent dye (e.g., nanoparticles, quantum dots, Eosin yellow, luminol, fluorescein, coumarin, cyanine, rhodamine, acridine orange, malachite green, zinc sulfide, any other suitable fluorescent material, or a combination thereof), that may allow a user to visually differentiate the optical fiber assembly 250 from the core 212 (e.g., by shining a suitable excitation light on the core 212 so as to cause the fiber encapsulation layer 254 to fluoresce). In some embodiments, the fiber encapsulation layer 254 may include a phosphorescent material (e.g., phosphorous).

In some embodiments, the fiber encapsulation layer 254 may have a thickness T in a range of about 0.125 mm to about 0.5 mm, inclusive (e.g., 0.125, 0.15, 0.15, 0.1, 0.15, 0.2, 0.25, 0.3, 0.35, 0.4, 0.45, or 0.5 mm, inclusive). In some embodiments, the thickness T of the fiber encapsulation layer 254 and/or the thickness thereof may be sufficient to withstand the extrusion or pultrusion process used to form the core 252 or otherwise, the strength member 210. As shown in FIG. 2, the optical fiber assembly 250 is axially aligned with a central axis (or longitudinal axis) of the core 212, for example, to reduce micro-bending stresses on the optical fiber assembly 250.

FIG. 3 is a side cross-section view of a conductor 300, according to an embodiment. The conductor 300 is similar to the conductor 200, for example, the conductor 300 includes a strength member 310 including a core 312 and an encapsulation layer 314, an optical fiber assembly 350, that may be substantially similar to the core 112, 212, the encapsulation layer 114, 214, and the optical fiber assembly 150, 250, respectively, as described, and therefore not described in further detail herein. The conductor 300 also includes a conductor layer 320 disposed around strength member 310, and having an outer coating 330 disposed around the conductor layer 320. The conductor layer 320 and the outer coating 330, may be substantially similar to the conductor layer 120, 220 and the outer coating 130, 230, previously described, and therefore not described in further detail herein. While not shown, in some embodiments, an insulating layer (e.g., the insulating layer 222) may be interposed between the outer coating 330 and the conductor layer 320, as previously described.

Different from the conductor 200, the conductor 300 also includes an inner coating 316 disposed on an outer surface of the encapsulation layer 314, for example, interposed between the encapsulation layer 314 and the conductor layer 320. In some embodiments, the inner coating 316 may be formulated to have a solar absorptivity of less than 0.5 (e.g., less than 0.5, less than 0.4, less than 0.3, less than 0.2, or less than 0.1) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11.0, 12.0, 13.0, 14.0, or 15.0 microns, inclusive), at an operating temperature of the conductor 300 in a range of 90 degrees Celsius to 250 degrees Celsius, inclusive (e.g., 90, 100, 120, 140, 160, 180, 200, 220, 240, or 250 degrees Celsius, inclusive). Thus, the inner coating 316 may be configured to reflect a substantial amount of solar radiation in the wavelength of equal to or less than 2.5 microns (e.g., at least 50% of solar radiation in a wavelength of equal to or less than 2.5 microns that is incident on the encapsulation layer 314). In some embodiments, a thickness of the inner coating 316 may be in a range of 1 micron to 500 microns, inclusive (e.g., 1, 5, 10, 20, 30, 40, 50, 60, 70, 80, 90, 100, 150, 200, 250, 300, 350, 400, 450, or 500 microns, inclusive). Coating on core surface or on the encapsulation layer 314 surface might be thermally non-conductive or have poor thermal conductivity, for example, include ceramics, to minimize conductive heat transfer between the passively heated composite core 312 and the conductive encapsulation layer 314 metal with resistance heating. In some embodiments, a thickness of the inner coating 316 may be in a range of 50 microns to 300 microns, inclusive (e.g., 50, 100, 150, 200, 250, or 300 microns, inclusive). In some embodiments, a ratio of a thickness of the outer coating 330 to the thickness of the inner coating 316 may be in a range of about 1:1 to about 10:1, inclusive (e.g., 1.1, 2.1, 3:1, 4:1, 5:1, 6:1, 7:181, 91, or 10:1, inclusive) The inner coating 316 may be substantially similar to the inner coating 116 or may include any inner coating described in the '726 application.

The optical fiber assembly 350 includes a fiber core 352 and a fiber encapsulation layer 354. In some embodiments, the thickness T of the fiber encapsulation layer 354 and/or the thickness thereof may be sufficient to withstand the extrusion or pultrusion process used to form the core 352 or otherwise, the strength member 310. Similar to the strength member 210 of FIG. 2, the optical fiber assembly 350 is axially aligned with a central axis (or longitudinal axis) of the core 312, for example, to reduce micro-bending stresses on the optical fiber assembly 350.

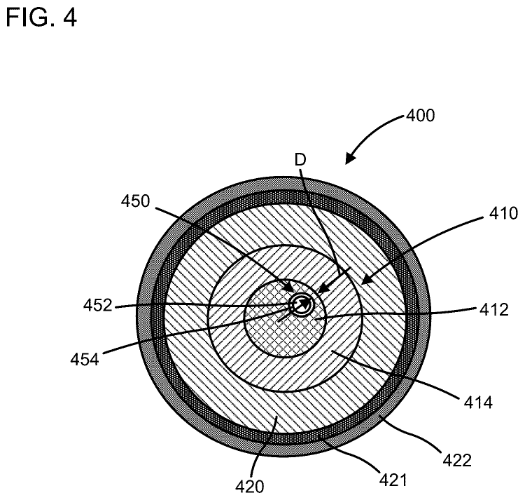

FIG. 4 is a side cross-section view of a conductor 400, according to an embodiment. The conductor 400 is similar to the conductor 200, for example, the conductor 400 includes a strength member 410 including a core 412, an encapsulation layer 414, and an optical fiber assembly 450, that may be substantially similar to the core 112, 212, the encapsulation layer 114, 214, and the optical fiber assembly 150, 250, respectively, as previously described herein. The conductor 400 also includes a conductor layer 420 disposed around strength member 410, and having an outer coating 430 disposed around the conductor layer 340. The conductor layer 420 and the outer coating 430, may be substantially similar to the conductor layer 120, 220 and the outer coating 130, 230, previously described, and therefore not described in further detail herein. While not shown, in some embodiments, an insulating layer (e.g., the insulating layer 222) may be interposed between the outer coating 430 and the conductor layer 420, as previously described. In some embodiments, an inner coating (e.g., the inner coating 116, 316) may optionally be disposed around the encapsulation layer 414 or otherwise interposed between the strength member 410 and the conductor layer 420, as previously described herein.

Different from the conductor 200 and 300, the optical fiber assembly 450 is disposed proximate to a radially outer edge of the core 412 such that the optical fiber assembly 450 is radially offset from the central axis (or longitudinal axis) of the core 412. In some embodiments, a shortest radial distance D from an outer edge of optical fiber assembly 450 to a radial outer edge of the core 112 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive).

In some embodiments, the shortest radial distance may be at least 0.1 mm. In some embodiments, the shortest radial distance may be at least 0.2 mm. In some embodiments, the shortest radial distance may be at least 0.3 mm. In some embodiments, the shortest radial distance may be at least 0.4 mm. In some embodiments, the shortest radial distance may be at least 0.5 mm. In some embodiments, the shortest radial distance may be at least 0.6 mm. In some embodiments, the shortest radial distance may be at least 0.7 mm. In some embodiments, the shortest radial distance may be at least 0.8 mm. In some embodiments, the shortest radial distance may be at least 0.9 mm. In some embodiments, the shortest radial distance may be at least 1.0 mm. In some embodiments, the shortest radial distance may be at least 1.2 mm. In some embodiments, the shortest radial distance may be at least 1.4 mm. In some embodiments, the shortest radial distance may be at least 1.6 mm. In some embodiments, the shortest radial distance may be at least 1.8 mm. In some embodiments, the shortest radial distance may be at least 2.0 mm. In some embodiments, the shortest radial distance may be at least 2.2 mm. In some embodiments, the shortest radial distance may be at least 2.4 mm. In some embodiments, the shortest radial distance may be at least 2.6 mm. In some embodiments, the shortest radial distance may be at least 2.8 mm. In some embodiments, the shortest radial distance may be at least 3.0 mm.

In some embodiments, the shortest radial distance may be at most 3 mm. In some embodiments, the shortest radial distance may be at most 2.8 mm. In some embodiments, the shortest radial distance may be at most 2.6 mm. In some embodiments, the shortest radial distance may be at most 2.4 mm. In some embodiments, the shortest radial distance may be at most 2.2 mm. In some embodiments, the shortest radial distance may be at most 2.0 mm. In some embodiments, the shortest radial distance may be at most 1.9 mm. In some embodiments, the shortest radial distance may be at most 1.8 mm. In some embodiments, the shortest radial distance may be at most 1.7 mm. In some embodiments, the shortest radial distance may be at most 1.6 mm. In some embodiments, the shortest radial distance may be at most 1.5 mm. In some embodiments, the shortest radial distance may be at most 1.4 mm. In some embodiments, the shortest radial distance may be at most 1.3 mm. In some embodiments, the shortest radial distance may be at most 1.2 mm. In some embodiments, the shortest radial distance may be at most 1.1 mm. In some embodiments, the shortest radial distance may be at most 1.0 mm. Positioning the optical fiber assembly 450 proximate to the radially outer edge of the core 412 may make it easier and/or faster for a user to access the optical fiber assembly 450 by removing or peeling only a portion of the core 412, thereby reducing installation, or repair time and cost.

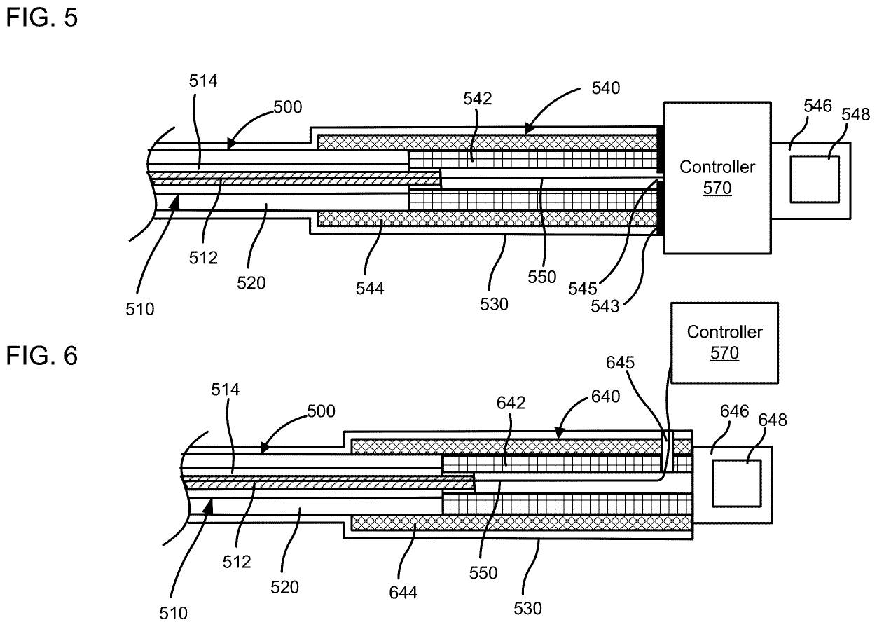

FIG. 5 is a side cross-section view of a coupler or a fitting 540 coupled (e.g., crimped) to an axial end of a conductor 500. The conductor 500 includes a strength member 510 and a conductor layer 520 disposed on the strength member 510. The strength member 510 includes a core 512 having an encapsulation layer 514 disposed therearound. An optical fiber assembly 550 is disposed in the core 512. The core 512, the encapsulation layer 514, the optical fiber assembly 550, and the conductor layer 520 may be substantially similar to the core 112, 212, 312, or 412, the encapsulation layer 114, 214, 314, or 414, the optical fiber assembly 150, 250, 350, or 450, and the conductor layer 120, 220, 320, 420, respectively, and therefore, not described in further detail herein.

The coupler or fitting 540 includes a body 542 (e.g., a cylindrical body) and defining an internal volume configured to receive a portion of an axial end of the strength member 510 conductor 500. For example, a predetermined length of the conductor layer 520 of the conductor 500 may be removed (e.g., a portion having a length in a range of about 150 mm to about 350 mm, inclusive, from the axial end of the conductor 500). The cross-sectional width of the inner volume of the body 542 may be greater than the outer cross-sectional width of the strength member 510 to allow insertion of the axial end of the strength member 510 into the body 542. The cross-sectional width of the inner volume of the body 542 may be then reduced, for example, by crimping to cause the inserted portion of the body 540 to be crimped or otherwise secured to the strength member 510. A sleeve 544 may be disposed around the body 542 (e.g., circumferentially around the body 542) and configured to contact the conductor layer 520 so as to electrically couple the coupler 540 to the conductor layer 520, and also to be physically coupled to the conductor layer 520, for example, via crimping. The coupler 540 may also include a connecting portion 546 defining a keyhole 548. The connecting portion 546 may be configured to be coupled to corresponding hooks or connectors located on poles (e.g., tension towers) from which the conductor 650 may be suspended.

As previously described, the composite material from which the core 512 is formed may be susceptible to crush force damage. However, the encapsulation layer 514 disposed around the core 512 also serves as a protection layer to protect the core 512 from the compressing force exerted during crimping of the body 542 around the strength member 510. This advantageously allows conventional crimp fittings or couplers to be used with the conductor 500, providing installation ease and flexibility, and reducing cost. While FIG. 5 depicts a particular configuration of a fitting or coupler 540 it should be appreciated that any crimp coupler can be used with the conductor 500 or any other conductor described herein, including those for coupling one conductor to another.

In some embodiments, the conductor 500 may be coated with a coating 530. Moreover, the coating 530 is also coated on at least a portion of the fitting or coupler 540. The coating 530 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees Celsius to 250 degrees Celsius, inclusive. For example, the coating 530 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius. In some embodiments, the outer coating 530 may cause a reduction in operating temperature of the conductor 530 as well as the fitting or coupler at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive), as described herein. The coating 530 may include the outer coating 130, 230, 330, 430, 530 or any other coating described herein.

As shown in FIG. 5, a portion of the optical fiber assembly 550 extends axially outwards of the core 512 of the strength member 550 into the internal volume defined by the body 542 of the body of the coupler. As previously described, the optical fiber assembly 550 carries, communicates, or transmits signals that may be indicative of one or more operating parameters of the conductor 500 such as, for example, mechanical parameters such as strain (e.g., distributed strain), stress, sag, change in length, etc., temperature (e.g., distribution temperature), vibration (e.g., aeolian and/or galloping vibrations) or electrical operating parameters (e.g., detecting line faults or breaks) or conductor or surrounding environment. These signals have to be interpreted (e.g., decoded, filtered, amplified, etc.) to determine the values of the various operating parameters.

In some embodiments, a controller 570 is coupled to (e.g., integrated with) the coupler 540. For example, the controller 570 may be disposed at an axial end of the coupler 540 between the body 542 and the connecting portion 546 of the coupler 540, and may be integrated with the coupler 540. A housing of the controller 570 may be coupled to a wall 543 of the coupler 540 that is located at the axial end of the coupler 540 and to the connecting portion 546 (e.g., welded thereto). In other embodiments, the controller 570 may be disposed on and coupled to any other wall of the coupler 570, for example, a sidewall of the coupler 540 that is parallel to a longitudinal axis of the coupler 540 (e.g., a sidewall of the sleeve 544).

The controller 570 is configured to receive a sensing signal that is indicative of the operating parameter(s) of the conductor 500 from the optical fiber assembly 550, and at least one of transmit the sensing signal to a receiver (e.g., a satellite, a transponder, a transceiver, a remote server, etc.), or interpret the signal to determine a value of the operating parameter and transmit the value of the operating parameter to the receiver. For example, in some embodiments, the controller 570 may be configured to receive the raw sensing signal form the optical fiber assembly 550 and at least temporary log or store the raw sensing signals into a memory of the controller 570 as well as transmit the sensing signals to the external receiver. In some embodiments, the controller 570 may be configured to filter the sensing signal(s) to remove noise and generate a filtered signal, and transmit the filtered signal to the external receiver. In some embodiments, the controller 570 may be configured to interpret the sensing signal to determine the value(s) of the operating parameter(s) and transmit the value(s) of operating parameter(s) to the external receiver.

An aperture 545 is defined in the wall 543 of the coupler 540, and a portion of the optical fiber assembly 550 is routed through the aperture 545 to the controller 570 and communicatively coupled to the controller 570. As shown in FIG. 5, the wall 543 is located at an axial end of the coupler 540 that is opposite the conductor 500. In other embodiments, the aperture 545 can be defined in any other wall of the coupler 540 proximate to the controller 570, for example, a sidewall of the coupler that is parallel to a longitudinal axis of the coupler 540. In some embodiments, a sealing member (e.g., an O-ring or gasket) may be disposed in the aperture 545, and configured to seal the inner volume of the coupler 540 from an external environment. In such embodiments, the optical fiber assembly 550 may be routed through the sealing member. In some embodiments, a wall of the controller 570 may form a wall of the coupler 540, and an optical connector may be provided on the wall of the controller 570 to which the optical fiber assembly 550 can be interfaced. The controller 570 may be configured to wirelessly transfer signals indicative of the optical signals received from the optical fiber assembly 550 to a receiver. This alleviates having to draw the optical fiber assembly 550 out of the coupler 540 for interfacing with the controller 570.

FIG. 6 is a side cross-section view of another coupler 640 having the conductor 500 coupled thereto, according to an embodiment. The coupler 640 includes a body 642 (e.g., a cylindrical body) and defining an internal volume configured to receive a portion of an axial end of the strength member 510 of the conductor 500 similar to the body 542 of the coupler 540. A sleeve 644 may be disposed around the body 642 (e.g., circumferentially around the body 642) and configured to contact the conductor layer 520 so as to electrically couple the coupler 640 to the conductor layer 520. The coupler 640 may also include a connecting portion 646 defining a keyhole 648. The connecting portion 646 may be configured to be coupled to corresponding hooks or connectors located on poles (e.g., tension towers) from which the conductor 650 may be suspended. In some embodiments, the outer coating 530 may disposed on an outer surface of the coupler 640 (e.g., around the sleeve 644).

Different from the coupler 540, the controller 570 is not coupled to the coupler 640. Instead, the controller 570 is disposed remote from the coupler 640, for example, on a pole or tower to which the connecting portion 646 is coupled. An aperture 645 is defined through a sidewall of the coupler, for example, through sidewalls of the body 642 and the sleeve 644 that are parallel to a longitudinal axis of the coupler 640. A portion of the optical assembly 550 is routed through the aperture 645 and communicatively coupled to the controller 570. In other embodiments, the aperture 645 may be defined through any other sidewall of the coupler 640 or a wall located at the axial end of the coupler 640.

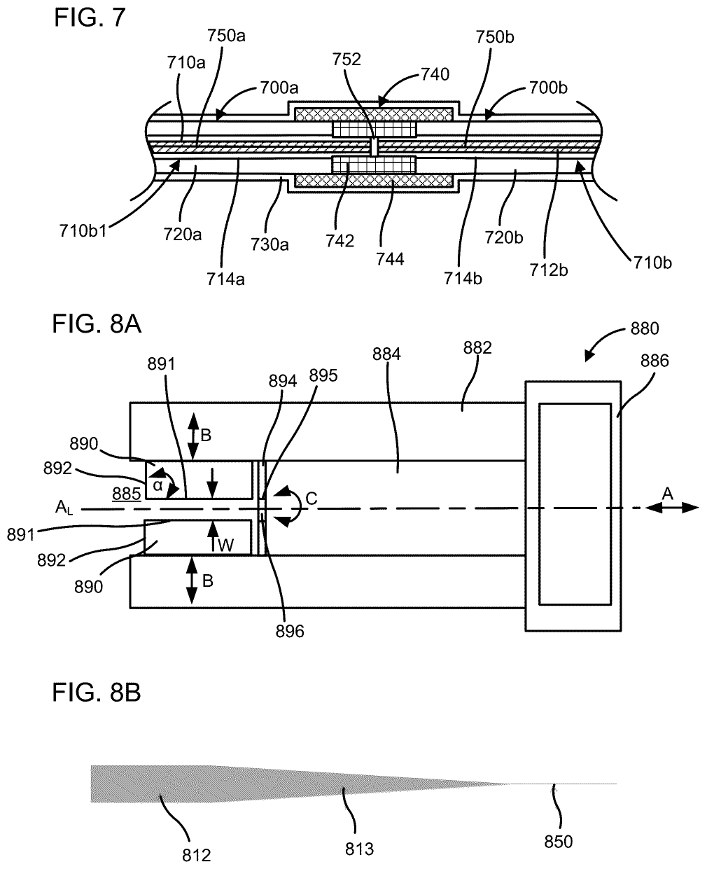

FIG. 7 is a schematic illustration of another fitting or coupler 740 that may be used to splice a first conductor 700b1 including a first optical assembly 750a to a second conductor 700b2 including a second optical assembly 750b such that the first optical assembly 750a is coupled to the second optical assembly 750b, according to an embodiment. In some embodiments, the coupler 740 may be coated with a low solar absorptivity and high radiative emissivity coating 730 (e.g., the coating 530 previously described herein). The first conductor 700a includes a first strength member 710a including a first core 712a and a first encapsulation layer 714a, and a first conductor layer 720a disposed around the first strength member 710a. Similarly, the second conductor 700b includes a second strength member 710b including a second core 712b and a second encapsulation layer 714b, and a second conductor layer 720b disposed around the second strength member 710b. The first optical assembly 750a is disposed in the first core 712a and the second optical assembly 750b is disposed in the second core 712b. The conductors 700a and 700b may be substantially similar to the conductor 500, and are therefore not described in further detail herein.

The coupler or fitting 740 includes a body 742 (e.g., a cylindrical body) defining an internal volume configured to receive portions of corresponding axial ends of the first strength member 710a and the second strength member 700b. For example, a predetermined length of the conductor layers 720a, 720b of the conductors 700a, 700b may be removed (e.g., a portion having a length in a range of about 150 mm to about 350 mm, inclusive from the axial end of the conductors 700a, 700b). The cross-sectional width of the inner volume of the body 742 is less than the outer cross-sectional width of the strength members 710a, 710b such that insertion of the axial end of the first strength member 710a and the second strength member 710b into the body 742 causes the inserted portion of the encapsulation layers 712a, 712b to be crimped and spliced to one another. A sleeve 744 may be disposed around the body 742 (e.g., circumferentially around the body 742) and configured to contact the conductor layers 720a, 720b so as to electrically couple the coupler 740 to the conductor layers 720a, 720b.

As previously described, the composite material from which the core 712a, 712b is formed may be susceptible to crush force damage. However, the encapsulation layers 714a, 714b disposed around the cores 712a, 712b also serve as a protection layers to protect the cores 712a, 712b from the compressive force exerted during crimping of the body 742a, 742b around the strength members 710a, 710b. Moreover, the first optical fiber assembly 750a is coupled to the second optical fiber assembly 750b, for example, via an optical coupler 752 (e.g., fused-fiber optical coupler, a micro-optics optical coupler, a planar waveguide optical coupler, or any other suitable optical coupler). In this manner, the first optical fiber assembly 750a may communicate sensing signals measured by the first optical fiber assembly 750a to the second optical fiber assembly 750b or vice versa for eventual communication to a controller (e.g., the controller 570).

In order to couple an axial end of a conductor such as the conductors 500, 700a, or 700b to a coupler (e.g., the coupler 540, 640, or 740), and to access the optical fiber assembly disposed therein for coupling to a controller (e.g., the controller 570) or to another optical fiber assembly, at least a portion of a conductor layer disposed at an axial end of the conductor, as well as a portion of the encapsulation layer and core of the strength member of the conductor also has to be removed to allow a user (e.g., individual(s) responsible for installing and/or repairing the conductors) to access the optical fiber assembly disposed within the core. While the portion of the conductor layer may be removed by stripping or peeling back portions of strands of the conductor layer, special tools may be desired to allow the user to remove the portions of the encapsulation layer and/or the core without damaging the optical fiber assembly disposed in the core. For example, FIG. 8A is a schematic illustration of a stripping tool 880 (hereinafter “tool 880”) for stripping an encapsulation layer (e.g., the encapsulation layer 114, 214, 314, 414, 514, 714a, or 714b) of a strength member (e.g., the strength member 110, 210, 310, 410, 510, 710a, or 710b) of a conductor to allow access to a composite core (e.g., the composite core 112, 212, 312, 412, 512, 712a, or 712b) of the strength member and thereby, at least a portion of an optical fiber assembly (e.g., the optical fiber assembly 150, 250, 350, 450, 550, 750a, or 750b) disposed in the core, according to an embodiment.

The tool 880 includes a tool body 882 to which a handle 886 is coupled. The tool body 882 may be a longitudinal structure (e.g., a cylindrical structure) extending along a longitudinal axis AL and defines an inner volume 884. An opening 885 is defined at first end of the tool body 882 and is configured to receive an axial end of a strength member of a conductor through the opening 885. The body 882 may be formed from a strong and rigid material, for example, metals (e.g., iron, aluminum, steel, stainless steel, alloys, any other suitable metal or a combination thereof), plastics, polymers, or a combination thereof. The handle 886 is coupled to a second end of the body 882 opposite the first end. The handle 886 may include ergonomic features such as grips, grooves, indents, detents, protrusions, or any other suitable feature to facilitate a user to grip the handle 886. The handle 886 can be gripped by the user and enables the user to move the body 882 back and forth in an axial direction along the longitudinal axis AL in a first direction indicated by the arrow A so as to push the body around an axial end of a strength member of the conductor to draw the axial end of the strength member into the internal volume 884, or withdraw the strength member from the internal volume 884 through the opening 885.

The tool 880 may include two or more first blades 890 (e.g., 2, 3, 4, or even more blades) extending radially from an inner surface of the body 882 into the inner volume 884. In some embodiments, the first blades 890 may include a first cutting edge 891 (e.g., a sharpened edge) defined on a first edge of each of the first blades 890, which is parallel to or substantially parallel to the longitudinal axis AL. In some embodiments, each the first blades 890 may be radially spaced apart from an adjacent first blade 890 by the same radial distance, or the same the radial angle. For example, based on the number of first blades 890 provided in the tool 880, the first blades 890 may be spaced apart from each other by a radial angle of 180 degrees when two first blades 890 are provided, by a radial angle of 90 degrees when four first blades 890 are provided, by a radial angle of 60 degrees when six first blades 890 are provided, by a radial angle of 45 degrees, when eight first blades 890 are provided, and so on.

The first blades 890 may be formed from a hard material (e.g., stainless steel, carbon, ceramics, etc.) capable of penetrating or cutting into the encapsulation layer of the strength member as the body 884 is moved over the strength member causing the strength member to move into the inner volume 884. The first cutting edge 891 of adjacent blades may be spaced apart by a distance W that may correspond to a cross-sectional width (e.g., diameter) of the core of the strength member such that the first blades 890 form longitudinal slits in the encapsulation layer without any substantial penetration into the core. In some embodiments, the first blades 890 may be configured to radially displaced relative to each other in a direction shown by the arrow B so as to adjust the distance W between the first cutting edges 891 of opposing first blades 890. This may allow the tool 880 to accommodate various strength members having different cross-sectional width cores or different thickness encapsulation layers. In such embodiments, the at least a portion of the blades 890 may be configured to be withdrawn in to the body 884 (e.g., within radial slots defined in the body 884) to allow adjustment of the distance W. In other embodiments, the first blades 890 may be removably coupled to the body 884, for example, snap-fit or friction fit in the body 884, or coupled to the body 884 via coupling members such as screws, nuts, bolts, pins, etc. In such embodiments, the first blades 890 may be replaced with another set of blades, for example, new first blades once the first cutting edge 891 of the first blades 890 is worn, or to install first blades having different lengths so as to adjust the distance W between the first cutting edges 891 of corresponding blades based on the cross-sectional width of the strength member or a core thereof, as described herein.

In some embodiments, the first blades 890 may also include a second cutting edge 892 defined on a second edge 892 of the first blades 890 that is proximate to the opening 885 and extends in a direction orthogonal to the longitudinal axis AL. The second cutting edge 892 may further facilitate cutting into the encapsulation layer as the body 884 is pushed over the strength member. While shown as being oriented at angle α of about 90 degrees relative to the first cutting edge, i.e., substantially orthogonal to the first cutting edge 891 of the corresponding first blade 890 in FIG. 8A, in some embodiments, the angle α may be greater than 90, for example, in a range of about 120 degrees to about 150 degrees, inclusive. This may facilitate the second cutting edge 892 to slice or cut into the encapsulation layer as the body 884 is displaced over the strength member to form longitudinal slots therein. In some embodiments, the corner of the first blade 690 at the interface of the first cutting edge 891 and the second cutting edge 892 may be chamfered or curved, for example, to a provide a continuous curved cutting edge from the first cutting edge 891 to the second cutting edge 892.

The tool 880 also includes a second blade 894 disposed axially inward of the first blades 890 within the body 884. The second blade 894 may be a circular blade that defines a central opening 896 and a cutting edge 895 defined on a rim of the opening 896. The opening 896 may have a diameter corresponding to the cross-sectional width of the core. While FIG. 8A shows the second blade 896 as being a single structure, in some embodiments, the second blade 894 may include an assembly including a plurality of circumferential blades whose respective radial cutting edges define the opening 896. The second blade 894 is configured as a circumcizer such that as the body 884 and thereby, the second blade 894 is rotated in a clockwise or anti-clockwise direction about the longitudinal axis AL as indicated by the arrow C and advanced towards the strength member along the longitudinal axis A in the direction indicated by the arrow A, the cutting edge 895 peels the encapsulation layer of the core. The longitudinal slits already formed in the encapsulation layer by the first blades 890 may facilitate the peeling off of the encapsulation layer by the circumcision action of the second blade 894. In some embodiments, the first blades 890 may be radially withdrawn in the body 882 before circumcising and peeling of the encapsulation layer from the core by the second blade 894. In some implementations, the peeled encapsulation layer may be collected in the inner volume 884 as the encapsulation layer is peeled off the core at the axial end of the strength member. The stripped encapsulation layer may later be removed from the inner volume 884 and recycled.

In some embodiments, the first blades 890 and/or the second blade 894 may also be configured to machine or grind a portion of the core to expose the optical fiber assembly disposed therewithin. For example, the first blades 890 may be structured to also form longitudinal slits in the core up to a predetermined distance, and the second blade may be used to grind or remove a portion of the core. In some embodiments, the second blade 894 may include rotary blades such as those employed in rotary pencil sharpeners to grind the core to allow access to the optical fiber assembly. In some embodiments, a separate hand held grinding tool (e.g., a tool having rotary blades similar to a rotary pencil sharpener) may be used to grind or machine the core to enable the optical fiber assembly disposed therein to be accessed. In some embodiments, additionally or alternatively, at least a portion of the core may be removed using an appropriate solvent to access the optical fiber assembly. For example, FIG. 8B is a side view of an axial end of a composite core 812 of a strength member of a conductor that has been stripped off an encapsulation layer via the stripping tool of FIG. 8A and a portion of which has been removed to allow access to a portion of an optical fiber assembly 850 disposed therein.

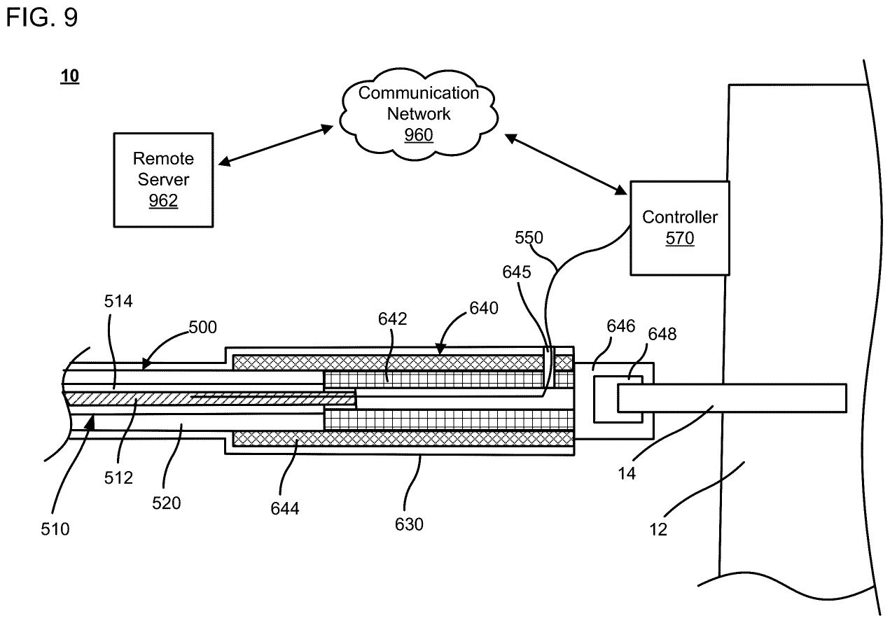

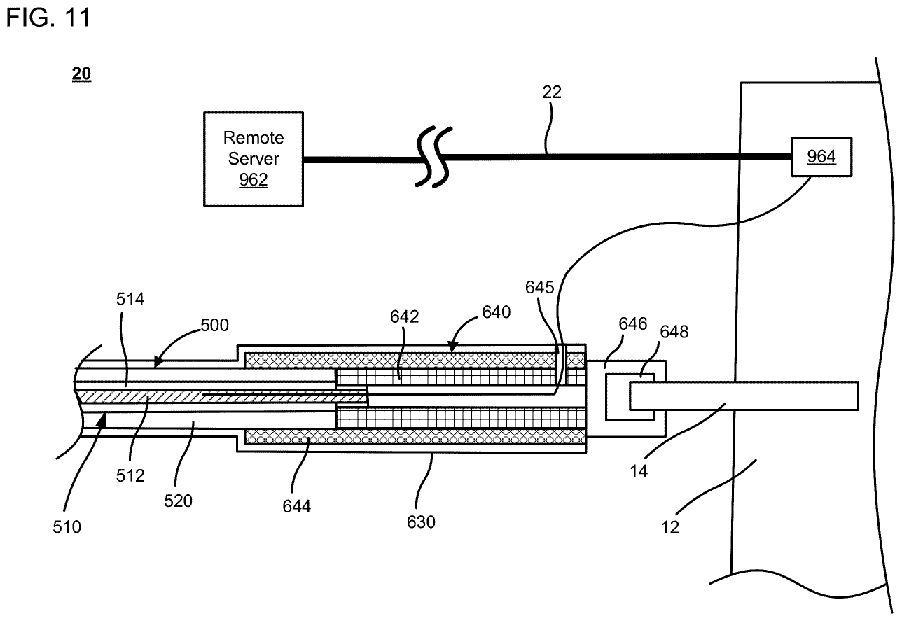

FIG. 9 is schematic illustration of a system 10 for sensing operating parameters of a conductor 500 and transmitting the operating parameters or determined values of the operating parameters to a remote server 962, according to an embodiment. The system 10 includes the conductor 500 coupled to the couple 640, as previously described. The coupler 646 is coupled or mounted to a pole 12 via a coupling member 14. For example, the coupling member 14 may include a bolt coupled to the pole 12, and includes a hook that is inserted through the keyhole 648 of mount the coupler 640 to the pole 12. While shown as being included in an above ground electrical transmission system 10 in FIG. 9 (and FIG. 11), in some embodiments, the conductor 500 may be included in an underground system in which the conductor 500, or at least portions thereof or buried beneath the ground to be included in an underground electrical transmission system. Thus the various concepts described herein are equally applicable to over ground as well as underground systems, and all such systems are intended to be within the scope of this disclosure.

The controller 570 may also be mounted or disposed on the pole 12. In other embodiments, the controller 570 may be coupled to the coupler, for example, as described with respect to the coupler 540. The optical fiber assembly 550 is routed through the aperture 645 and communicatively coupled to the controller 570, as previously described. The controller 570 may be configured to receive a sensing signal from the optical fiber assembly 550 and transmit the sensing signal to remote server 962, or interpret the sensing signal to determine a value(s) of the operating parameter(s) and transmit the value of the operating parameter to the remote server 962 via a communication network 960.

The remote server 962 may include a local server or a cloud based server configured to receive the sensing signals or values of the operating parameters from the controller 570 and store the values, and may also be configured to analyze the values to determine an operating status of the conductor 500 based on the operating parameters of the conductor 500. For example, the remote server 962 may be configured to determine mechanical parameters such as strain (e.g., distributed strain), stress, sag, change in length, etc., or temperature (e.g., distribute temperature) of the conductor 500, or electrical operating parameters (e.g., detect line faults or breaks), or any other suitable parameter of the conductor 500 to determine the operational health of the conductor 500 (e.g., sag exceeding a threshold, temperature of conductor or environment exceeding a threshold, a break in the conductor 500, or any other fault with the conductor 500 and indicate the fault to a user (e.g., generate alarms or faults codes indicative of a type of fault and location of the fault).

The communication network 960 is any suitable Local Area Network (LAN) or Wide Area Network (WAN) configured to receive sensing signals or values of the operating parameters from the controller 570 and transmit the sensing signals or values of the operating parameters to the remote server 962. In some embodiments, the communication network 960 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (lx), General Packet Radio Service (GPRS), Personal Communications Service (PCS), 802.11X, ZigBee, Bluetooth, Wi-Fi, any suitable wired network, combination thereof, and/or the like. In some embodiments, the communication network 960 may include a satellite based network (e.g., the STARLINK® satellite network).

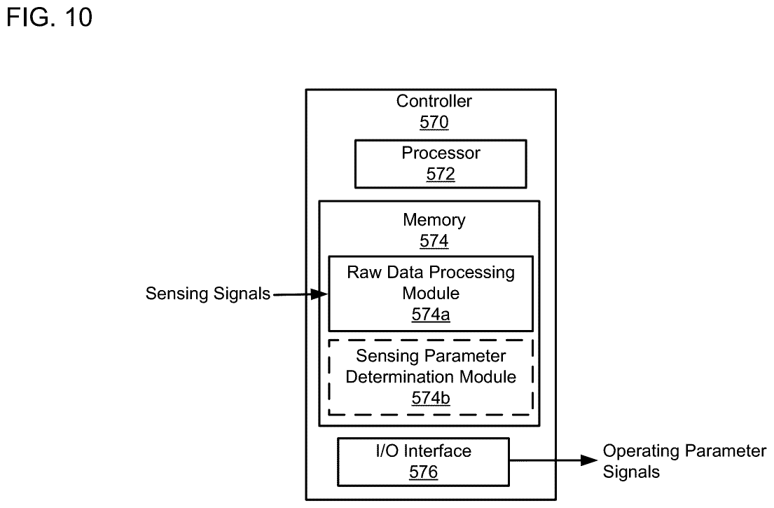

FIG. 10 is schematic block diagram of the controller 570 that is included in the systems of FIGS. 5, 6, and 9, according to an embodiment. While FIG. 570 illustrates a particular embodiment of the controller 570, any other suitable controller configured to perform the operations described herein may be used. The controller 570 include a processor 572, a memory 574, and an input/output (I/O) interface 576. The processor 572 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 574 (e.g., Random Access Memory (RAM), Read-Only Memory (ROM), Non-volatile RAM (NVRAM), Flash Memory, hard disk storage, etc.) stores data (e.g., operating parameter data) and/or computer code (e.g., operating parameter filtering or processing algorithms, etc.) for facilitating at least some of the various processes described herein. The memory 574 may include tangible, non-transient volatile memory, or non-volatile memory. The memory 574 may include a non-transitory processor 574 readable medium having stores programming logic that, when execute by the processor 574, controls the operations of the controller 570. In some arrangements, the processor 572 and the memory 574 form various processing circuits described with respect to the controller 570.

The I/O interface 576 is structured for sending and receiving data (e.g., over a communication network) from the controller 570. Accordingly, the I/O interface 576 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like.

In some embodiments, the controller 570 may include various circuitries or modules configured to perform the operations of the controller 570. For example, as shown in FIG. 10, the controller 570 includes a raw data processing module 574a, and optionally, a sensing parameter determination module 574b. In one configuration, the raw data processing module 574a, and the sensing parameter determination module 574b are embodied as machine or computer-readable media (e.g., stored in the memory 574) that is executable by a processor, such as the processor 572. As described herein and amongst other uses, the machine-readable media (e.g., the memory 574) facilitates performance of certain operations of the raw data processing module 574a, and the sensing parameter determination module 574b to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, wireless network, etc.).

In some embodiments, the raw data processing module 574a, and the sensing parameter determination module 574b may be embodied as one or more circuitry components including, but not limited to, processing circuitry, network interfaces, peripheral devices, input devices, output devices, sensors, etc. In some embodiments, the raw data processing module 574a, and the sensing parameter determination module 574b may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the raw data processing module 574a, and the sensing parameter determination module 574b may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the raw data processing module 574a, and the sensing parameter determination module 574b may also include programmable hardware devices such as field programmable gate arrays, programmable array logic, programmable logic devices or the like. In this regard, the raw data processing module 574a, and the sensing parameter determination module 574b may include one or more memory devices for storing instructions that are executable by the processor(s) of the raw data processing module 574a, and the sensing parameter determination module 574b. The one or more memory devices and processor(s) may have the same definition as provided below with respect to the memory 574 and the processor 572.

In the example shown, the controller 570 includes the processor 572 and the memory 574. The processor 572 and the memory 574 may be structured or configured to execute or implement the instructions, commands, and/or control processes described herein with respect to the raw data processing module 574a, and the sensing parameter determination module 574b. Thus, the depicted configuration represents the aforementioned arrangement in which the raw data processing module 574a, and the sensing parameter determination module 574b are embodied as machine or computer-readable media. However, as mentioned above, this illustration is not meant to be limiting as the present disclosure contemplates other embodiments such as the aforementioned embodiment including the raw data processing module 574a, and the sensing parameter determination module 574b, or embodiments in which at least one circuit of the raw data processing module 574a, and the sensing parameter determination module 574b are configured as a hardware unit. All such combinations and variations are intended to fall within the scope of the present disclosure. In some embodiments, the one or more processors may be shared by multiple circuits (e.g., the raw data processing module 574a, and the sensing parameter determination module 574b) may comprise or otherwise share the same processor which, in some example embodiments, may execute instructions stored, or otherwise accessed, via different areas of memory 254.

The raw data processing module 574a is configured to receive sensing signals from the optical fiber assembly 550 or any other optical fiber assembly described herein, and process the sensing signals. In some embodiments, the raw data processing module 574a may include a photodetector configured to transform the optical signals received from the optical fiber assembly 500 into electrical signals that can be communicated by the controller 570 to the remote server 962. In some embodiments, the raw data processing module 574a may also be configured to filter the sensing signals using hardware or software filters (e.g., low pass filters, high pass filters, band pass filters, Fourier transform filters, band stop filter, notch filter, comb filter, all pass filter, cut-off frequency filter, roll off filter, transition band filter, ripple filter, any other suitable filter or a combination thereof) configured to filter noise from the raw sensing signals received from the optical fiber assembly.

In embodiments in which the controller 570 includes the sensing parameter determination module 574b, the sensing parameter determination module 574b may be configured to analyze the processed sensing signals and determine one or more operating parameters of the conductor 500 (e.g., any of the operating parameters described herein) from the processed sensing signals. The I/O interface 576 is configured to generate an operating parameter signal indicative of the processed operating parameters and/or the operating parameter values obtained therefrom. The operating parameter signal may be communicated to the remote server 962 via the communication network 960 as previously described herein.

Many electrical transmission systems that are used to communicate electrical energy via conductors suspended between poles or towers also include communication fibers suspended between the same poles or towers. Such communication fibers [e.g., optical ground wire (OPGW) fibers] are used to communicate communication signals such as cable or internet signals to remote servers, but may also be used to communicate the sensing signals measured by optical fiber assemblies included in conductors. For example, FIG. 11 is schematic illustration of a system 20 for transmitting sensing signals measured from the conductor 500 by the optical fiber assembly 550, according to an embodiment. The system 20 is similar to the system 10 and includes the conductor 500 coupled to the pole 12 via the coupler 640, as previously described herein. However, different from the system 10, the system 20 also includes a communication fiber 22 coupled to the pole 12, and configured to transmit communication signals. The communication fiber 22 may be configured to communicate communication signals to the remote server 964 or any other remote server. An optical coupler 964 may be disposed on the pole 12 and is coupled to the communication fiber 22. The optical fiber assembly 550 is routed through the aperture 645 of the coupler 640, and communicatively coupled to the optical coupler 964. The optical coupler 964 may include, for example, an X coupler, a combiner, a splitter, star coupler, a tree coupler, any other suitable optical coupler or a combination thereof, and is configured to communicate the sensing signals measured by the optical fiber assembly 550 to the communication fiber 22, which in turn communicates the sensing signals to the remote server 962 along with the communication signals.

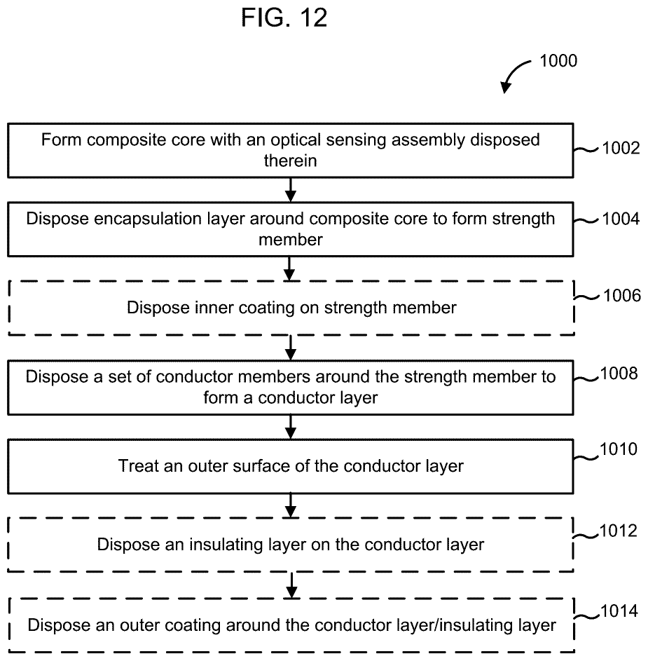

FIG. 12 is a schematic flow chart of a method 1000 for manufacturing a conductor (e.g., the conductor 100, 200, 300, 400, 500, 700a, 700b) including a strength member (e.g., the strength member 110, 210, 310, 410, 510, 710a, 710b) that includes a composite core (e.g., the core 112, 212, 312, 412, 512, 712a, 712b) having an optical fiber assembly (e.g., the optical fiber assembly 150, 250, 350, 450, 550, 750a, 750b) disposed in the composite core and an encapsulation layer (e.g., the encapsulation layer 114, 214, 314, 414, 514, 714a, 714b) disposed around the composite core, and a conductor layer (e.g., the conductor layer 120, 220, 320, 420, 520, 720a, 720b) disposed around the strength member, according to an embodiment. While the method 1000 is described with respect to the conductor 100, this should not be construed as limiting the disclosure and various operations of the method 1000 may be used to form any conductor including a composite core and an optical fiber assembly disposed in the composite core, as described herein.

The method 1000 includes forming the composite core 112 with the optical fiber assembly 150 disposed therein, at 1002. For example, a composite material (e.g., any of the composite materials described herein with respect to the composite core 112) may be heated to a temperature about equal to or greater than a first glass transition temperature or melting temperature of the composite material but less than the second glass transition temperature or melting temperature of the fiber encapsulation layer 154 of the optical fiber assembly 150, and the composite material molded, pulled, pultruded, or extruded along with the optical fiber assembly 150 to form the core with the optical fiber assembly 150 disposed or embed therein, and being in intimate contact with the core 112. Because the second glass transition temperature or melting temperature of the fiber encapsulation layer 154 of the optical fiber assembly 150 is greater than the first glass transition temperature or melting temperature, heating of the composite material during forming of the core 112 does not damage the fiber encapsulation layer 154. Thus, the optical fiber assembly 150 can be disposed in, embedded in, or integrated into the core 112 while damage to the fiber encapsulation layer 154 is inhibited due to its higher second glass transition temperature or melting temperature.

In some embodiments, the composite core 112 may have a first color and the fiber encapsulation layer 152 may have a second color different from the first color. For example, the composite material used to form the core 112 may have a dark color (e.g., black or near black color), and the fiber encapsulation layer 154 may have a bright color such as, for example, white, bright pink, bright green, bright orange, bright blue, or any other suitable color that has substantial contrast with the color of the core 112 to allow a user to visually differentiate the optical fiber assembly 150 from the core 112, as previously described. In some embodiments, the fiber encapsulation layer 154 may include a fluorescent material or include a fluorescent dye, as previously described.

The optical fiber assembly 150 may be disposed at any suitable location in the core 112. In some embodiments, the optical fiber assembly 150 may be disposed approximately along a central axis of the strength member 110, or a central axis of the conductor 100 in embodiments in which the conductor 100 has a single strength member 110, for example, to reduce micro bending losses, as previously described herein. In some embodiments, the optical fiber assembly 150 may be disposed proximate to a radially outer edge of the core 112, for example, parallel to the central axis of the core 112 proximate to an outer peripheral edge of the core 112. This may allow a user to easily access the optical fiber assembly 150 by removing only a small portion of the core 112, as described herein. In some embodiments, a shortest radial distance from an outer edge of optical fiber assembly 150 to a radial outer edge of the core 112 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive). In some embodiments, the shortest radial distance may be at most 3 mm.

At 1004, the encapsulation layer 114 is disposed around the core 112. The encapsulation layer 114 may include a conductive material or an insulative material, as previously described herein. In some embodiments, the encapsulation layer 114 may be disposed around the core 112 using a conforming machine or a similar function machine, and be optionally further drawn to achieve target characteristics of the encapsulation layer 114 (e.g., a desired geometry or stress state). The conforming machines or the similar machines used for disposing the encapsulation layer 114 may allow quenching of the encapsulation layer 114. The conforming machine may be integrated with stranding machine, or with pultrusion machines used in making fiber reinforced composite strength members such that the encapsulation layer 114 may disposed on the composite core 112 simultaneously during the forming process of the core 112. In some embodiments, multiple encapsulation layers 114 may be disposed around the core 112, which may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pretensioned or precompressed aluminum, as previously described.

In some embodiments, the inner coating 116 may be disposed on an outer surface of the encapsulation layer 114, at 1004, for example, via painting spray coating, depositing and cross-linking, shrink wrapping, any other suitable method, or combination thereof. In some embodiments, the inner coating 116 may be formulated to have a low absorptivity of less than 0.5 at a wavelength in a range of 2.5 microns to 15 microns, inclusive, at an operating temperature in a range of 60 degrees C. to 250 degrees Celsius, inclusive, and may be formed from any suitable material, as described herein.

At 1008, a set of conductive members (e.g., conductive strands) are disposed over the strength member 110 (e.g., around the encapsulation layer 114 or around the inner coating 116 disposed around the encapsulation layer 114) to form the conductor layer 120. The conductive strands may be formed from aluminum, aluminum alloy, copper or copper alloy including micro alloy as conductive media, etc. In some embodiments, the conductor layer 120 may include conductive strands including Z, C, or S wires to keep the outer strands in place. The conductor layer 120 may have any suitable cross-sectional shape, for example, circular, triangular, trapezoidal, etc. In some embodiments, the conductor layer 120 may include stranded aluminum layer that includes round or trapezoidal aluminum strands. In some embodiments, the conductor layer 120 may include Z shaped aluminum strands. In some embodiments, the conductor layer 120 may include S shaped aluminum strands.

The conductive strands may be disposed around strength member 110 using a conforming machine or any suitable method, as described herein. In some embodiments, the conductor layer 120 may include a first set of conductive strands included in disposed around the strength member 110 in a first wound direction (e.g., wound helically around the strength member 110 in a first rotational direction), a second set of conductive strands disposed around the first set of strands in a second wound direction (e.g., wound helically around the first set of conducive strands in a second rotational direction opposite the first rotational direction), and may also include a third set of strands wound around the second set of strands in the first wound direction.

In some embodiments, an outer surface of the conductor layer 120 (e.g., an outer surface of each conductive strand, or a radially outer surface of only the outer most conductive strands included in the conductor layer 120) is treated, at 1010. For example, the outer surface of the conductive strands of the conductor layer 120 may be cleaned using any suitable method such as, for example, via acid, solvents, and/or texturized using mechanical means (e.g., sand blasted) to facilitate adhesion of the outer coating 130 to the outer surface of the conductor layer 120.

In some embodiments, an insulating layer 122 is disposed on the conductor layer 120, at 1012. The insulating layer 122 may be formed from any suitable electrically insulative material, for example, rubber, plastics, or polymers (e.g., polyethylene, PTFE, high density polyethylene, cross-linked high density polyethylene, etc.), and may be configured to electrically isolate or shield the conductor 100. In some embodiments in which the insulating layer 122 is disposed around the conductor layer 120, the outer surface of the insulating layer 122 may be cleaned or texturized (e.g., via sand blasting).

At 1014, the outer coating 130 is disposed around the conductor layer 120, or around the insulating layer 122 in embodiments in which the insulating layer 122 is disposed around the conductor layer 120. The outer coating 130 may be disposed using any suitable method, for example, via painting spray coating, depositing and cross-linking, shrink wrapping, any other suitable method, or combination thereof. The outer coating 130 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees C. to 250 degrees Celsius, inclusive. For example, the outer coating 130 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius. In some embodiments, the outer coating 130 may be configured to cause a reduction in operating temperature of the conductor 100 at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive), as described herein. The coating 130 may include microstructures and nanoporosities, and may be formed from any suitable material, as described herein. In some embodiments, the outer coating 130 may additionally, or alternatively be formulated to have an erosion resistance that is at least 5% greater than an erosion resistance of aluminum or aluminum alloys (e.g., an erosion resistance that is at least about 100% greater than the erosion resistance of aluminum or aluminum alloys.). In some embodiments, the outer coating 130 may have a Vicker hardness of greater than 200. Experimental Examples

Various optical fiber assemblies having various cladding thicknesses or fiber encapsulation layers were embedded in the core of strength members of conductors according to the embodiments described herein, and the micro-bending induced optical energy transmission loss for each of them was determined. It should be appreciated that these examples are for illustrative purposes only and not meant to limit the disclosure.

### Comparative Example 1

A G.652.D optical fiber (Comp. Ex. 1 fiber) was embedded into a core of a strength member. The G.652.D fiber includes a silica cladding disposed around a central core, the cladding having a thickness of about 625 μm. The optical fiber is mingled with one of the carbon fiber tow into the resin bath before entering the curing die. The optical fiber was also introduced with resin wetted carbon fibers, then directly pulled into the longitudinally placed curing die by a caterpillar in the pultrusion process. The core included carbon fibers and epoxy which are cured at about 200 degrees Celsius inside a die with a diameter of about 8 mm. The Comp. Ex. 1 fiber was embedded proximate to a central axis of the core. The micro-bending induced optical energy transmission loss of the Comp. Ex. 1 fiber was about 0.25 dB/km before embedding in the core, and increased to greater than 300 dB/km after embedding. The optical signal loss was measured in reflection in real-time using an optical light source, an optical circulator, and optical power meter. The entering optical fiber was pre-cleaved and the cleaved end protected inside a sealed short metal tube. The reflected light power from the cleaved end-surface before entering into pultrusion die was recorded as reference for loss calculation.

### Comparative Example 2

A G.657.A2 optical fiber (Comp. Ex. 2 fiber) was embedded into a core of a strength member. The core included a carbon composite material and had a diameter of about 8 mm. Optical fiber integration is performed similar to the Comp. Ex. 2 fiber described herein. The micro-bending induced optical energy transmission loss of the Comp. Ex. 2 fiber was about 0.25 dB/km before embedding in the core, and increased to greater than 100 dB/km after embedding.

### Example 1

A G.657.B3 optical fiber (Ex. 1 fiber) was embedded into a core of a strength member. The G.657.B3 fiber includes a silica cladding disposed around the central core, the cladding having a thickness of about 62.5 μm, and an acrylate protective or buffer layer disposed on the cladding. Optical fiber integration is performed similar to the Comp. Ex. 2 fiber described herein. The composite core included a carbon composite material and had a diameter of about 8 mm. The Ex. 1 fiber was embedded proximate to a central axis of the core. The micro-bending induced optical energy transmission loss of the Ex. 1 fiber was about 0.2 dB/km before embedding in the core, and increased to only about than 5 dB/km after embedding.

### Example 2

A G.652.D optical fiber (Ex. 2 fiber) was embedded into a core of a strength member The G.652.D optical fiber included a silica cladding having a thickness of about 200 μm disposed on a central core. The core included a carbon composite material and had a diameter of about 8 mm. The Ex. 2 fiber was embedded proximate to a central axis of the core. Optical fiber integration is performed similar to the Comp. Ex. 2 fiber described herein. The micro-bending induced optical energy transmission loss of the Ex. 2 fiber was about 0.2 dB/km before embedding in the core, and increased to only about than 1 dB/km after embedding.

As used herein, the terms “about” and “approximately” generally mean plus or minus 10% of the stated value For example, about 0.5 would include 0.45 and 0.55, about 10 would include 9 to 11, about 1000 would include 900 to 1100.

As utilized herein, the terms “substantially” and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled.” and the like as used herein mean the joining of two members directly or indirectly to one another. Such joining may be stationary (e.g., permanent) or moveable (e.g., removable, or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus, comprising:
a strength member, including:
a core formed of a composite material, the core having a first glass transition temperature or melting temperature,
an encapsulation layer disposed around the core, and
an optical fiber assembly disposed in the core, the optical fiber assembly including a fiber core and a fiber encapsulation layer disposed around the core, the fiber encapsulation layer having a second glass transition temperature or melting temperature that is greater than the first glass transition temperature or melting temperature, or processing temperature of the strength member; and
a conductor layer disposed around the strength member.

2. The apparatus of the claim 1, wherein the first glass transition temperature or melting temperature, or processing temperature of the strength member is in a range between about 60 degrees Celsius and about 350 degrees Celsius.

3. The apparatus of the claim 2, wherein the second glass transition temperature or melting temperature is in a range between about 80 degrees Celsius and about 450 degrees Celsius.

4. The apparatus of claim 1, wherein the core has a first color and the fiber encapsulation layer has a second color different from the first color.

5. The apparatus of the claim 1, wherein the optical fiber assembly is disposed proximate to a central axis of the core.

6. The apparatus of claim 1, wherein the optical fiber assembly is disposed proximate to a radially outer edge of the core.

7. An assembly, comprising:
the apparatus of claim 1; and
a coupler coupled to an axial end of the apparatus, the coupler defining an aperture through a wall of the coupler, a portion of the optical assembly being routed through the aperture.

8. An apparatus, comprising:
a strength member, including:
a core formed of a composite material,
an encapsulation layer disposed around the core, and
an optical fiber assembly disposed in the core, the optical fiber assembly including a fiber core and a fiber encapsulation layer disposed around the core, the fiber core including a central core and a cladding disposed around the central core, the cladding having a thickness of in a range of about 80 μm and to about 1,000 μm; and
a conductor layer disposed around the strength member.

9. The apparatus of claim 8, wherein the cladding has a thickness in a range of about 200 μm to about 1,000 μm.

10. The apparatus of claim 8, wherein the central core has diameter in a range of about 2 μm to about 10.5 μm.

11. The apparatus of claim 8, wherein the central core includes a germanium doped silica and the cladding includes an undoped silica.

12. The apparatus of claim 8, wherein the fiber encapsulation layer includes a temperature resistant layer.

13. The apparatus of claim 12, wherein the core of the strength member has a first glass transition temperature or melting temperature, or the strength member has a processing temperature, and the temperature resistant layer has a second glass transition temperature or melting temperature that is greater than the first glass transition temperature or melting temperature, or processing temperature of the strength member.

14. The apparatus of claim 12, wherein the fiber encapsulation layer further includes a jacket disposed on the temperature resistant layer, the jacket having a Young's modulus of greater than about 30 MPa.

15. The apparatus of claim 8, wherein the optical fiber assembly has a bend radius of less than 250 mm with a micro-bending induced optical energy transmission loss of equal to or less than about 5.0 dB/km.

16. The apparatus of claim 8, wherein the fiber encapsulation layer further comprises:
an inner moisture exclusion layer disposed on the fiber core, the inner moisture exclusion layer configured to inhibit moisture ingress into the fiber core.

17. The apparatus of claim 8, further comprising:
an outer moisture exclusion layer disposed around the optical fiber assembly, the outer moisture exclusion layer configured to inhibit moisture ingress into the optical fiber assembly.

18. An apparatus, comprising:
a strength member, including:
a core formed of a composite material,
an encapsulation layer disposed around the core, and
an optical fiber assembly disposed in the core, the optical fiber assembly including a fiber core and a fiber encapsulation layer disposed around the core, the optical fiber assembly having a bend radius of equal to or less than about 250 mm such that the optical fiber assembly has a micro-bending induced optical energy transmission loss of equal to or less than about 5.0 dB/km.

19. The apparatus of claim 18, wherein the optical fiber assembly includes a G.657.B3 single mode fiber.

20. The apparatus of claim 18, wherein the optical fiber assembly has a bend radius of less than 10 mm.

21. The apparatus of claim 18, wherein the optical fiber assembly has a micro-bending induced loss of equal to or less than about 1.0 dB/km.

22. The apparatus of claim 21, wherein the fiber core includes:
a central core; and
a cladding disposed around the central core, the cladding having a thickness in a range of about 80 μm to about 1,000 μm.

23. The apparatus of claim 18, wherein the fiber core includes:
a central core including germanium doped silica; and
a cladding disposed around the central core, the cladding including an undoped silica.

24. The apparatus of claim 18, wherein the fiber encapsulation layer includes a thermal resistant layer.

25. The apparatus of claim 24, wherein the fiber encapsulation layer further includes a jacket disposed on the thermal resistant layer, the second layer having a Young's modulus of greater than about 30 MPa.

26. The apparatus of claim 18, wherein the fiber encapsulation layer further comprises:
an inner moisture exclusion layer disposed on the fiber core, the inner moisture exclusion layer configured to inhibit moisture ingress into the fiber core.

27. The apparatus of claim 18, further comprising:
an outer moisture exclusion layer disposed around the optical fiber assembly, the outer moisture exclusion layer configured to inhibit moisture ingress into the optical fiber assembly.

28. A system, comprising:
a conductor, comprising:
a strength member, including:
a core formed of a composite material,
an encapsulation layer disposed around the core, and
an optical fiber assembly disposed in the core, the optical fiber assembly including a fiber core and a fiber encapsulation layer; and
a conductor layer disposed around the strength member; and
a controller communicatively coupled to the optical fiber assembly, the controller configured to:
receive a sensing signal from the optical fiber assembly, the sensing signal indicative of an operating parameter of the conductor, and
at least one of: transmit the sensing signal to a receiver, or interpret the signal to determine a value of the operating parameter and transmit the value of the operating parameter to the receiver.

29. The system of claim 28, wherein at least a portion of the conductor is buried underground.

30. The system of claim 28, further comprising:
a coupler coupled to an axial end of the conductor, the controller integrated with the coupler.
